(19) United States
(12) Patent Application Publication
(10) Pub. No.: US 2025/0059088 A1
(43) Pub. Date: Feb. 20, 2025

(54) METHODS FOR CHARACTERIZING EXPANDABLE PERLITE, ARTICLES CONTAINING EXPANDABLE PERLITE AND METHODS FOR MAKING SAME

(71) Applicant: Saint-Gobain Placo, Courbevoie (FR)

(72) Inventors: Remi Lespiat, Devon, PA (US); Hiva Baradari, Pantin (FR); Florian Beaugnon, Aubervilliers (FR); Marion Grange, Mississauga (CA); Julie Godefroid, Malvern, PA (US); Mikayel Arzakantsyan, Montigny-les-Cormeilles (FR)

(21) Appl. No.: 18/807,089

(22) Filed: Aug. 16, 2024

Related U.S. Application Data
(60) Provisional application No. 63/520,440, filed on Aug. 18, 2023.

(30) Foreign Application Priority Data
Sep. 20, 2023 (EP) 23306564.8

(51) Int. Cl. C04B 14/18; C04B 28/14; C04B 40/00; C04B 103/63; C04B 111/00; C04B 111/28; G01N 5/04; G01N 25/00

(52) U.S. Cl. CPC C04B 14/18; C04B 28/14; C04B 40/0082; G01N 5/04; G01N 25/00; C04B 2103/63; C04B 2111/0062; C04B 2111/285

(57) ABSTRACT

The present disclosure relates generally to methods for characterizing unexpanded perlite, e.g., with respect to its expandability as well as articles containing expandable perlite, such as gypsum materials, fire-resistant building boards and other fire-resistant materials, and methods for making the same. The present inventors have determined thermogravimetric methods for characterizing unexpanded perlite with high predictive power for the selection of highly-expandable perlites. The disclosure also relates to materials including unexpanded perlites that meet certain threshold values with respect to these characterization methods.

### CROSS-REFERENCE TO RELATED APPLICATIONS

The present application claims the benefit of priority of European Patent Application no. 23306564.8, filed Sep. 20, 2023, and U.S. Provisional Patent Application No. 63/520,440, filed Aug. 18, 2023, each of which is hereby incorporated herein by reference in its entirety.

### BACKGROUND OF THE DISCLOSURE

### 1. Field

The present disclosure relates generally to methods for characterizing unexpanded perlite, e.g., with respect to its expandability as well as articles containing expandable perlite, such as gypsum materials, fire-resistant building boards and other fire-resistant materials, and methods for making the same.

### 2. Technical Background

Gypsum building products (e.g., known variously as wallboard, ceiling board, and “drywall”) are panels made of a gypsum core sandwiched between two layers of liner, often paper, on the outside surfaces of the gypsum core. They are widely used as construction materials due to their ease of fabrication, high mechanical strength, low thermal conductivity, resistance to spread of fire, and soundproofing properties. The quality of a gypsum board is strongly dependent on its core, which is fabricated by the hydration of slurry including calcium sulfate hemihydrate into a set body. To control the properties of gypsum board, additives are often added to the slurry during the board making process. For example, foaming agents, inorganic compounds, and other additives may be included in the slurry to modulate the density, strength, and/or fire-resistance properties of the board.

To provide fire-resistant plasterboards, it has been common to incorporate fire-resistant additives to the plaster slurry during the board making process to ultimately improve the fire-resistance properties of the board. By including fire-resistant additives, the plasterboards have reduced board shrinkage at elevated temperatures, indicative of improved structural integrity. Some additives known to improve the fire-resistant properties include mineral additives, such as vermiculites and perlites. Vermiculite and perlite are known to expand upon heating. The expansion is driven by the release of water vapor and can contribute to a reduction of shrinkage at high temperature.

Expandable materials like vermiculite and unexpanded perlite are used in a variety of other products as well, including joint compounds and skim coat materials.

However, not all perlites have adequate thermal expansion to provide the desired fire-resistant properties to a particular end product, be it a plasterboard, another gypsum-based material, or otherwise. As such, there remains a need in the art to provide methods of characterizing perlites that can provide improved fire-resistant properties to gypsum materials.

### SUMMARY

In one aspect, the present disclosure provides a method for characterizing an unexpanded perlite with respect to thermal expansion, the method comprising:
subjecting the unexpanded perlite to thermogravimetric analysis (TGA) at a first heating rate of at least 10° C./minute over a first temperature range from a first lower limit of no more than 700° C. to a first upper limit of at least 800° C.;
determining a first mass loss over the first temperature range; and
optionally, characterizing the unexpanded perlite as high-expansion perlite if the first mass loss is at least a first threshold value,
   wherein the first threshold value is for instance at least 0.1 wt %, preferably at least 0.2 wt %, more preferably at least 0.7 wt %, or even at least 0.75 wt %.

In another aspect, the present disclosure provides a method for characterizing an unexpanded perlite with respect to thermal expansion, the method comprising:
subjecting the unexpanded perlite to thermogravimetric analysis (TGA) at a second heating rate of at least 20° C./minute over a second temperature range from a second lower limit of in the range of 500-700° C. to a second upper limit of at least 700° C., the second temperature range covering at least 100° C. in temperature difference;
determining a second mass loss, the second mass loss being an excess mass loss over the second temperature range, the excess mass loss being defined as a mass loss in excess of a mass loss represented by a line interpolated on a graph of mass loss vs. temperature from the second lower limit to the second upper limit; and
optionally, characterizing the unexpanded perlite as high-expansion perlite if the second mass loss is at least a second threshold value,
wherein the second threshold value is for instance at least 0.0 wt %, preferably at least 0.001 wt %, more preferably at least 0.04 wt %, even more preferably at least 0.07 wt %.

In another aspect, the present disclosure provides a method for characterizing an unexpanded perlite with respect to thermal expansion performance, the method comprising:
providing a D50 particle size of the unexpanded perlite;
determining a third mass loss of unexpanded perlite, the third mass loss being a difference between a stabilized mass of the unexpanded perlite at a third lower temperature that is in the range of 400-550° C. and a stabilized mass of the unexpanded perlite at a third upper temperature of at least 600° C.; and
optionally, characterizing the unexpanded perlite as high-expansion perlite if the third mass loss is at least a third threshold value, and
   the D50 particle size of the sample is at least a fourth threshold value,
   wherein
   the third threshold value is for instance at least 0.1 wt %, preferably at least 0.45 wt %, more preferably at least 0.5 wt %, and
   the fourth threshold value is for instance at least 50 microns, preferably at least 250 microns, more preferably at least 400 microns, or even at least 500 microns.

In another aspect, the present disclosure provides a method for characterizing an unexpanded perlite with respect to thermal expansion performance, the method comprising performing one of the following:
(a)
   subjecting the unexpanded perlite to thermogravimetric analysis (TGA) at a first heating rate of at least 10° C./minute over a first temperature range from a first lower limit of no more than 700° C. to a first upper limit of at least 800° C.;
   determining a first mass loss over the first temperature range; and
   characterizing the unexpanded perlite as high-expansion perlite if the first mass loss is at least a first threshold value;
   wherein the first threshold value is at least 0.1 wt %.
(b)
   subjecting the unexpanded perlite to thermogravimetric analysis (TGA) at a second heating rate of at least 20° C./minute over a second temperature range from a second lower limit of in the range of 500-700° C. to a second upper limit of at least 700° C., the second temperature range covering at least 100° C. in temperature difference;
   determining a second mass loss, the second mass loss being an excess mass loss over the second temperature range, the excess mass loss being defined as a mass loss in excess of a mass loss represented by a line interpolated on a graph of mass loss vs. temperature from the second lower limit to the second upper limit; and
   characterizing the unexpanded perlite as high-expansion perlite if the second mass loss is at least a second threshold value,
   wherein the second threshold value is at least 0.0 wt %; and
(c)
   providing a D50 particle size of the unexpanded perlite;
   determining a third mass loss of the unexpanded perlite, the third mass loss being a difference between a stabilized mass of the sample at a third lower temperature that is in the range of 400-550° C. and a stabilized mass of the sample at a third upper temperature of at least 600° C.; and
   characterizing the unexpanded perlite as high-expansion perlite if the third mass loss is at least a third threshold value, and
   the D50 particle size of the sample is at least a fourth threshold value,
   wherein the third threshold value is at least 0.1 wt %, and the fourth threshold value is at least 50 microns.

In another aspect, the present disclosure provides a fire-resistant set gypsum material comprising:
a set body of calcium sulfate dihydrate; and
dispersed in the set body of calcium sulfate dihydrate, an unexpanded perlite, the unexpanded perlite having one or more of
   (a) a first mass loss of at least a first threshold value, the first threshold value being at least 0.1 wt %, the first mass loss being determined by subjecting the unexpanded perlite to thermogravimetric analysis (TGA) at a first heating rate of 20° C./minute over a first temperature range from a first lower limit of 700° C. to a first upper limit of 900° C. and determining as the first mass loss the mass lost over the first temperature range;
   (b) a second mass loss of at least a second threshold value, the second threshold value being at least 0.0 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
   (c)
      (i) a third mass loss of at least a third threshold value, the third threshold value being at least 0.1 wt %, the third mass loss being a difference between a stabilized mass of the unexpanded perlite at a third lower temperature of 500° C. and a stabilized mass of the sample at a third upper temperature that is 1000° C.; and
      (ii) a D50 particle size of at least a fourth threshold value, the fourth threshold value being 50 microns.

In another aspect, the present disclosure provides a fire-resistant set gypsum material comprising:
a set body of calcium sulfate dihydrate; and dispersed in the set body of calcium sulfate dihydrate, an unexpanded perlite, the unexpanded perlite having one or more of
   (a) a first mass loss of at least a first threshold value, the first threshold value being at least 0.7 wt %, the first mass loss being determined by subjecting the unexpanded perlite to thermogravimetric analysis (TGA) at a first heating rate of 20° C./minute over a first temperature range from a first lower limit of 700° C. to a first upper limit of 900° C. and determining as the first mass loss the mass lost over the first temperature range;
   (b) a second mass loss of at least a second threshold value, the second threshold value being at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
   (c)
      (i) a third mass loss of at least a third threshold value, the third threshold value being at least 0.45 wt %, the third mass loss being a difference between a stabilized mass of the unexpanded perlite at a third lower temperature of 500° C. and a stabilized mass of the sample at a third upper temperature that is 1000° C.; and
      (ii) a D50 particle size of at least a fourth threshold value, the fourth threshold value being 400 microns.

In another aspect, the present disclosure provides a fire-resistant building board comprising a set gypsum core having a first major surface and a second, opposing major surface, wherein the set gypsum core comprises:
a set body of calcium sulfate dihydrate; and unexpanded perlite dispersed in the set body of calcium sulfate dihydrate, the unexpanded perlite having one or more of
(a) a first mass loss of at least a first threshold value, the first threshold value being at least 0.7 wt %, the first mass loss being determined by subjecting the unexpanded perlite to thermogravimetric analysis (TGA) at a first heating rate of 20° C./minute over a first temperature range from a first lower limit of 600° C. to a first upper limit of 800° C. and determining as the first mass loss the mass lost over the first temperature range;
(b) a second mass loss of at least a second threshold value, the second threshold value being at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
(c)
   (i) a third mass loss of at least a third threshold value, the third threshold value being at least 0.45 wt %, the third mass loss being a difference between a stabilized mass of the unexpanded perlite at a third lower temperature of 500° C. and a stabilized mass of the sample at a third upper temperature that is 1000° C.; and
   (ii) a D50 particle size of at least a fourth threshold value, the fourth threshold value being 400 microns.

In another aspect, the present disclosure provides a fire-resistant building board comprising a set gypsum core having a first major surface and a second, opposing major surface, wherein the set gypsum core comprises (preferably, is) a fire-resistant set gypsum material as defined herein.

In another aspect, the present disclosure provides a method of forming a fire-resistant building board as defined herein (in particular, comprising a set gypsum core having a first major surface and a second, opposing major surface), the method comprising:
providing a slurry comprising stucco, water, and unexpanded perlite;
allowing the slurry to set to form a wet gypsum core; and
drying the wet gypsum core at a temperature in the range of 50-350° C. to provide the set gypsum core,
wherein the unexpanded perlite has one or more of the characteristics (a), (b), and (c) as described herein.

In another aspect, the present disclosure provides a fire-resistant building board made by the method as described herein.

In another aspect, the present disclosure provides a fire-resistant set gypsum material comprising
a set body of calcium sulfate dihydrate; and
an unexpanded perlite dispersed in the set body of calcium sulfate dihydrate, the unexpanded perlite having one or more of the characteristics (a), (b), and (c) as described herein.

In various embodiments as otherwise described herein, the fire-resistant set gypsum material is provided as a layer on a substrate.

In another aspect, the present disclosure provides a fire-resistant coated building board comprising a building board having a first major surface and a second major surface; and a first layer of fire-resistant set gypsum material as described herein disposed on the first major surface of the building board.

In another aspect, the present disclosure provides a method of forming a fire-resistant set gypsum material as described herein, the method comprising:
providing a slurry comprising stucco, water, and unexpanded perlite;
allowing the slurry to set to from a wet gypsum material; and
drying the wet gypsum material at a temperature in the range of 50-350° C. to provide the set gypsum material,
wherein the unexpanded perlite has one or more of the characteristics (a), (b), and (c) as described herein.

In another aspect, the present disclosure provides fire-resistant set gypsum material made by the methods as described herein.

In some embodiments, the unexpanded perlite has (a) a first mass loss of at least a first threshold value, the first threshold value being at least 0.1 wt %, preferably at least 0.7 wt %, the first mass loss being determined by subjecting the unexpanded perlite to thermogravimetric analysis (TGA) at a first heating rate of 20° C./minute over a first temperature range from a first lower limit of 700° C. to a first upper limit of 900° C. and determining as the first mass loss the mass lost over the first temperature range.

In some embodiments, the first threshold value is at least 0.75 wt %.

In some embodiments, the unexpanded perlite has (b) a second mass loss of at least a second threshold value, the second threshold value being at least 0.0 wt %, preferably at least 0.001 wt %, more preferably at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit.

In some embodiments, the second threshold value is at least 0.07 wt %.

In some embodiments, the unexpanded perlite has (c) (i) a third mass loss of at least a third threshold value, the third threshold value being at least 0.1 wt %, preferably at least 0.45 wt %, the third mass loss being a difference between a stabilized mass of the unexpanded perlite at a third lower temperature of 500° C. and a stabilized mass of the sample at a third upper temperature that is 1000° C.; and (ii) a D50 particle size of at least a fourth threshold value, the fourth threshold value being 50 microns, preferably 250 microns, more preferably 400 microns, or even 500 microns.

In some embodiments, the third threshold value is at least 0.5 wt %.

In some embodiments, the fourth threshold value is at least 500 microns.

In some embodiments, the unexpanded perlite is present in the set gypsum material, in an amount of at least 0.5 wt %, based on the weight of the set gypsum material.

Other aspects of the disclosure will be apparent to the person of ordinary skill in the art based on the description herein.

### BRIEF DESCRIPTION OF THE DRAWINGS

The accompanying drawings are included to provide a further understanding of the methods of the disclosure, and are incorporated in and constitute a part of this specification. The drawings are not necessarily to scale, and sizes of various elements may be distorted for clarity. The drawings illustrate one or more embodiment(s) of the disclosure and together with the description serve to explain the principles and operation of the disclosure.

FIG. 1 is a graph of mass loss vs. temperature of perlite samples as measured by thermogravimetric analysis (TGA).

FIG. 2 is a graph of mass loss vs. temperature of perlite samples as measured by the second characterization method (b) described herein, showing an excess mass loss over a line interpolated between the second upper limit and the second lower limit.

FIG. 3 is a partial schematic cross-sectional view of a fire-resistant building board, according to one embodiment of the disclosure.

FIG. 4 is a partial schematic cross-sectional view of a layer of fire-resistant set gypsum material, according to one embodiment of the disclosure.

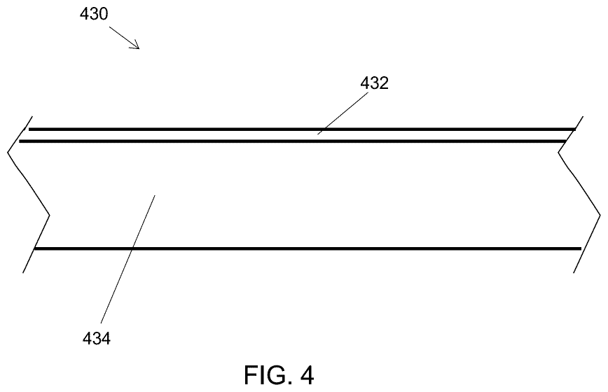

FIG. 5 is a partial schematic cross-sectional view of a coated building board, according to one embodiment of the disclosure.

FIG. 6 is a graph of perlite expansion vs. a first mass loss as determined by a first characterization method (a) as described herein.

FIG. 7 is a graph of perlite expansion vs. a second mass loss as determined by a second characterization method (b) as described herein.

FIG. 8 is a graph showing perlite expansion as a function of a third mass loss and a perlite median particle size, as determined by a third characterization method (c) as described herein.

### DETAILED DESCRIPTION

The present disclosure relates to with expandable perlite, which is useful in a number of materials and products, based on gypsum and otherwise. As noted above, perlite, a volcanic glass, is known to volumetrically expand at high temperatures. Thus, it can be used to improve fire performance in materials like the gypsum materials used in gypsum boards. This expansion is driven by the release of water vapor, which bursts bubbles in the glassy matrix of the perlite. However, the present inventors have noted that only a minor amount of the total water, referred to herein as “useful water,” significantly contributes to the thermal expansion at high temperature. This useful water generally corresponds to a fraction of the tightly-bound structural water present in the perlite. Previous work has described three types of water present in the perlite based on thermal mass loss measurement. They were interpreted as “surface water” (i.e., Type A), “loosely bound water” (i.e., Type B) and tightly bound water (type C) which is seen as significant as it is type C water that escapes at high temperature and could contribute to expansion. However, the present inventors have found that amount of so-called type C water depends on grain size and kinetics. In fact, part of the tightly bound water escapes with the loosely bound water if the grains are small or the heating ramp is slow. The present inventors have determined that it is desirable to differentiate between the three types of water (from the structure and form of bond to the glassy matrix) and the three peaks seen in TGA. This disclosure uses the term “useful water” to name the water contributing to the expansion of perlite and measured by TGA.

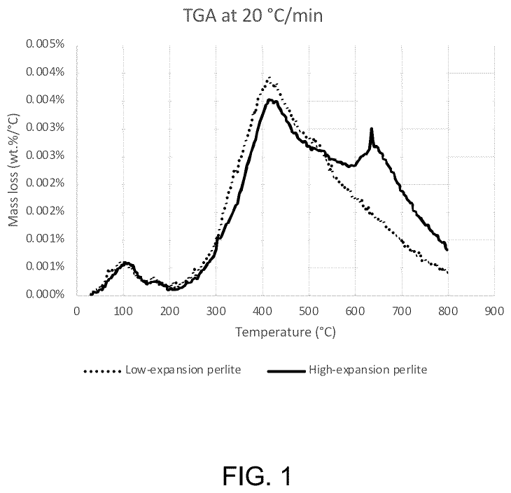

The present inventors have found that while amounts of water measured by the first TGA peak (Type A) and second TGA peak (mostly Type B water but with a contribution of type C) are similar across perlite samples, the amount of useful water (i.e., the remaining Type C water) can vary significantly, and, as such the expandability of unexpanded perlites can vary significantly. FIG. 1 is a graph of the release of water vapor measured in-situ by thermogravimetric analysis (TGA) (at a ramp 20° C./minute) for three different unexpanded perlite samples. From FIG. 1, it can be seen that the amounts of Type A and Type B water are roughly consistent across the two samples measured, but that the useful water varies significantly for each sample. The present inventors have found that unexpanded perlites with larger amounts of this “useful” water, provides more thermal expansion at high temperature than do unexpanded perlites with little or no useful water.

But the present inventors have found that this “useful water” can be difficult to measure. Notably, the present inventors have found that various factors, especially the heating temperature ramps and the unexpanded perlite grain size can influence the amount of useful water as measured by TGA. Without intending to be bound by theory, it is believed that these factors influence the timescale and kinetics of water release.

As described herein, the present inventors have developed methods to characterize unexpanded perlite for their amount of useful water and potential use as highly expandable materials, for example, as additives to improve fire performance in a variety of materials such as gypsum-based materials. These methods of characterizing unexpanded perlite have been found to correlate well with fire performance.

### Methods for Characterizing Perlite

As described above, the present inventors have developed a number of methods to identify highly-expandable unexpanded perlites. The methods are based on TGA or TGA and particle size measurements. Each of the methods provides different measurements of useful water, where unexpanded perlites that contain more than a threshold value of useful water can be characterized as “high-expansion” perlite suitable for a particular use. These threshold values will depend on the particular use, and can be selected by the person of ordinary skill in the art based on the disclosure herein. When the thresholds are properly selected, the methods provide an accurate characterization of the unexpanded perlite with respect to its expandability and desirability for use in a particular product or process.

The characterization methods of the disclosure are based on thermogravimetric analysis (“TGA”) methods. The methods and apparatuses used to perform the thermogravimetric analyses of the methods described herein are not particularly limited as long as the heating rates and/or temperature ranges used are as described herein. The person of ordinary skill in the art can select and configure a suitable thermogravimetric analyzer for use in performing the methods described herein. Of course, the TGA experiment itself can begin at a substantially lower temperature than a specified lower limit, and/or can continue past a specified upper limit. The person of ordinary skill in the art will appreciate that the recited lower and/or upper limits relate to the data used for analysis. The methods include the calculation of various mass loss values; these are calculated as a percentage of the original mass of the of material tested. The person of ordinary skill in the art can provide mass loss values from TGA data collected as indicated. For example, first and second mass losses can be determined by integration of the relevant traces on a graph of mass loss per unit temperature vs. temperature.

In one aspect the present disclosure provides a first method for characterizing an unexpanded perlite with respect to thermal expansion performance. The method includes subjecting the unexpanded perlite to thermogravimetric analysis (TGA) at a first heating rate of at least 10° C./minute over a first temperature range from a first lower limit of no more than 700° C. to a first upper limit of at least 800° C.; and determining a first mass loss over the first temperature range. The method can further include characterizing the unexpanded perlite as high-expansion perlite if the first mass loss is at least a first threshold value.

The first heating rate in this first characterization method of the disclosure is at least 10° C./min. For example, in various embodiments as otherwise described herein, the first heating rate is at least 15° C./min or at least 20° C./min. While the TGA measurement can be performed at a variety of rates, the present inventors note that extremely high rates are not necessary for good results. Accordingly, in various embodiments as otherwise described herein, the first heating rate is no more than 100° C./min, e.g., no more than 75° C./min, or no more than 50° C./min.

The first temperature range is defined by a first lower limit and a first upper limit. In this first characterization method, the first lower limit is no more than 700° C., and the first upper limit is at least 800° C. In various embodiments as otherwise described herein, the first lower limit is no more than 650° C., e.g., no more than 600° C. In various embodiments as otherwise described herein, the first lower limit is no more than 550° C., e.g., no more than 500° C. However, it can be desirable to exclude data at relatively cool temperatures. Accordingly, in various embodiments as otherwise described herein, the first lower limit is at least 300° C., or at least 350° C., or at least 400° C., or at least 450° C. In various embodiments as otherwise described herein, the first lower limit is at least 500° C., e.g., at least 550° C., or at least 600° C. or at least 650° C. The upper limit can also vary. For example, in various embodiments as otherwise described herein, the first upper limit is at least 850° C. or at least 900° C. Of course, the analysis need not be performed at extremely high temperatures, as the useful water will have substantially been lost at lower temperatures. Accordingly, in various embodiments as otherwise described herein, the first upper limit is no more than 1700° C. For example, in various embodiments as otherwise described herein, the first upper limit is no more than 1400° C., or no more than 1200° C., or no more than 1000° C.

The method as described herein includes determining a first mass loss over the first temperature range. This mass loss correspond to the water loss over this temperature range and, as the present inventors have determined, correlates to the amount of useful water, as described herein, present in the unexpanded perlite. This useful water is typically evident as a peak centered between 50° and 700° C. in a differential mass loss curve measured by TGA (see FIG. 1). However, this peak overlaps with a larger peak centered around 400° C., which corresponds to a release of water not contributing to expansion (understood by the inventors to be mostly nonstructural, or Type B, water). Due to the difficulty in separating overlapping mass loss peaks, in this first method as described herein, useful water is defined as the total mass loss over the first temperature range, as described herein, despite the fact that includes a contribution from the Type B peak in the mass loss curve. However, even with this approximation, the present inventors have found that this first mass loss is well correlated with perlite expansion and suitability for use as a high-expansion material.

As described above, the method can include characterizing the unexpanded perlite as high-expansion perlite if the first mass loss is at least a first threshold value. As noted above, the first threshold value can be selected depending on a desired end use and performance of the unexpanded perlite. This first characterization method can be used with respect to a variety of first threshold values (of course, limited by experimental error and instrument sensitivity), and is not limited to the examples of first threshold values described herein. In various embodiments as otherwise described herein, the first threshold value is at least 0.01 wt %, e.g., at least 0.05 wt %, or least 0.1 wt %. In various embodiments as otherwise described herein, the first threshold value is at least 0.2 wt %, e.g., at least 0.3 wt %. In various embodiments as otherwise described herein, the first threshold value is at least 0.4 wt %, e.g., at least 0.5 wt %. For example, in various embodiments as otherwise described herein, the first threshold value is in the range of 0.01-0.6 wt %, e.g., 0.01-0.5 wt %, or 0.01-0.4 wt %, or 0.01-0.3 wt %, or 0.01-0.2 wt %. In various embodiments as otherwise described herein, the first threshold value is in the range of 0.05-0.6 wt %, e.g., 0.05-0.5 wt %, or 0.05-0.4 wt %, or 0.05-0.3 wt %, or 0.05-0.2 wt %. In various embodiments as otherwise described herein, the first threshold value is in the range of 0.1-0.6 wt %, e.g., 0.1-0.5 wt %, or 0.1-0.4 wt %, or 0.1-0.3 wt %. In various embodiments as otherwise described herein, the first threshold value is in the range of 0.2-0.6 wt %, e.g., 0.2-0.5 wt %, or 0.2-0.4 wt %. In various embodiments as otherwise described herein, the first threshold value is in the range of 0.3-0.6 wt %, e.g., 0.3-0.5 wt %, or 0.4-0.6 wt %. In various embodiments, the first threshold value is at least 0.6 wt %. In various embodiments, the first threshold value is at least 0.7 wt %, e.g., at least 0.75 wt %, or at least 0.8 wt %. In various embodiments, the first threshold value is in the range of 0.5-1.5 wt %, e.g., 0.5-1.2 wt %, or 0.5-1 wt %, or 0.6-1.5 wt %, or 0.6-1.2 wt %, or 0.6-1 wt %, or 0.7-1.5 wt %, or 0.7-1.2 wt %, or 0.7-1 wt %, or 0.75-1.5 wt %, or 0.75-1.2 wt %, or 0.75-1 wt %, or 0.8-1.5 wt %, or 0.8-1.2 wt %, or 0.8-1 wt %.

Another aspect of the present disclosure provides a second method of characterizing a sample of unexpanded perlite with respect to thermal expansion performance. The method includes subjecting the unexpanded perlite to thermogravimetric analysis (TGA) at a heating rate of at least 20° C./minute over a second temperature range from a second lower limit in the range of 500-700° C. to a second upper limit of at least 700° C., the second temperature range covering at least 100° C. in temperature difference; determining a second mass loss, the second mass loss being an excess mass loss over the second temperature range, the excess mass loss being defined as a mass loss in excess of a mass loss represented by a line interpolated on a graph of mass loss vs. temperature from the second lower limit to the second upper limit; and optionally, characterizing the sample of perlite as high-expansion perlite if the second mass loss is at least a second threshold value.

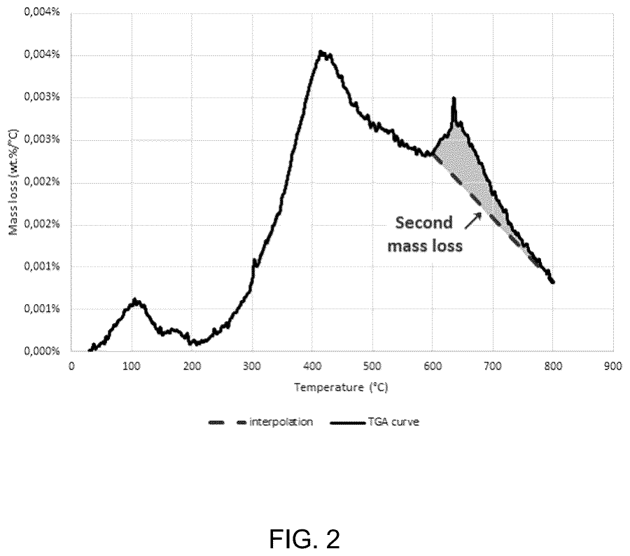

An example of the calculation of excess mass loss is shown in FIG. 2. Here, a graph of mass loss vs. temperature is shown for a sample of unexpanded perlite. In this example, the second lower limit is 600° C. and the second upper limit is 800° C. A line is interpolated between the mass loss value at 600° C. and the mass loss at 800° C. The excess mass loss is calculated as the area between the mass loss trace and the interpolated line, indicated by the shaded area. In the example of FIG. 2, the excess mass loss is positive (i.e., the mass loss trace is above the interpolated line). However, in some embodiments, i.e., when the mass loss trace is below the interpolated line, the determined excess mass loss can be negative. Negative values of excess mass loss can, in some cases, relate to useful unexpanded perlite materials. The person of ordinary skill in the art can correlate excess mass loss under given measurement and analysis conditions with desirable expandability for a given use, and can set a second threshold value accordingly.

As noted above, in this second characterization method of the disclosure, the heating rate is at least 20° C./min. For example, in various embodiments, the second heating rate is at least 25° C./min or at least 30° C./min. While the TGA measurement can be performed at a variety of rates, the present inventors note that extremely high rates are not necessary for good results. In various embodiments as otherwise described herein, the second heating rate is no more than 100° C./min, or no more than 75° C./min, or no more than 50° C./min.

The second temperature range is defined by a second lower limit and a second upper limit. As described above, in this second characterization method of the disclosure, the second lower limit is in the range of 500-700° C. For example, in various embodiments as otherwise described herein, the second lower limit is in the range of 500-650° C., or 500-600° C., or 500-550° C. In various embodiments as otherwise described herein, the second lower limit is in the range of 550-700° C., or 550-650° C., or 550-600° C.

As described above, in this second characterization method of the disclosure, the second upper limit is at least 700° C. For example, in various embodiments, the second upper limit is at least 725° C., or at least 750° C., or at least 800° C. Here, too, the analysis need not be performed at extremely high temperatures, as the useful water will have substantially been lost at lower temperatures. In various embodiments as otherwise described herein, the second upper limit is no more than 1700° C., or no more than 1400° C., or no more than 1200° C., or no more than 1000° C. The second lower limit and second upper limit are selected such that the second temperature range covers at least a 100° C. temperature difference.

This second characterization method of the disclosure includes determining a second mass loss that is an excess mass loss over a second temperature range, as described above. As with the first mass loss as described herein, this second mass loss is a measurement of the useful water of the perlite sample. However, in contrast to the first mass loss, this second mass loss is an excess mass loss, defined as a mass loss in excess of a mass loss represented by a line interpolated on a graph of mass loss vs. temperature between the second lower limit and the second upper limit. This second mass loss roughly accounts for mass loss from the larger Type B peak observed in the TGA. As with the first mass loss, the present inventors have found that this second mass loss is well-correlated with the perlite expansion, and thus the person of ordinary skill in the art can set a second threshold value for the second mass loss based on measurement and analysis conditions and the particular desired expandability of the material for a particular use.

In various embodiments, the method includes characterizing the unexpanded perlite as a high-expansion perlite if the second mass loss is at least a second threshold value. In various embodiments as otherwise described herein, the second threshold value is at least 0 wt %, e.g., at least 0.01 wt %, or at least 0.25 wt %. In various embodiments as otherwise described herein, the second threshold value is at least 0.04 wt %, e.g., at least 0.05 wt %, or at least 0.06 wt %. In various embodiments as otherwise described herein, the second threshold value is at least 0.07 wt %, e.g., at least 0.085 wt %. In various embodiments as otherwise described herein, the second threshold value is at least 0.1%, e.g., at least 0.1 wt % or at least 0.2 wt %. In various embodiments as otherwise described herein, the second threshold value is at least 0.25 wt %, e.g., at least 0.4 wt %. For example, in various embodiments as otherwise described herein, the second threshold value is in the range of 0-1 wt %, e.g., 0-0.6 wt %, or 0-0.4 wt %, or 0-0.2 wt %, or 0-0.1 wt %, or 0.01-1 wt %, or 0.01-0.6 wt %, or 0.01-0.4 wt %, or 0.01-0.2 wt %, or 0.01-0.1 wt %. In various embodiments as otherwise described herein, the second threshold value is in the range of 0.04-1 wt %, e.g., 0.04-0.6 wt %, or 0.04-0.4 wt %, or 0.04-0.2 wt %, or 0.04-0.1 wt %, or 0.05-1 wt %, or 0.05-0.6 wt %, or 0.05-0.4 wt %, or 0.05-0.2 wt %, or 0.05-0.1 wt %, or 0.06-1 wt %, or 0.06-0.6 wt %, or 0.06-0.4 wt %, or 0.06-0.2 wt %, or 0.06-0.1 wt %, or 0.07-1 wt %, or 0.07-0.6 wt %, or 0.07-0.4 wt %, or 0.07-0.2 wt %, or 0.07-0.1 wt %, or 0.08-1 wt %, or 0.08-0.6 wt %, or 0.08-0.4 wt %, or 0.08-0.2 wt %, or 0.08-0.1 wt %. In various embodiments as otherwise described herein, the second threshold value is in the range of 0.1-1 wt %, e.g., 0.1-0.6 wt %, or 0.1-0.4 wt %, or 0.1-0.2 wt %, or 0.1-0.1 wt %, or 0.15-1 wt %, or 0.15-0.6 wt %, or 0.15-0.4 wt %, or 0.2-1 wt %, or 0.2-0.6 wt %, or 0.2-0.4 wt %, or 0.25-1 wt %, or 0.25-0.6 wt %, or 0.25-0.4 wt %, or 0.3-1 wt %, or 0.3-0.6 wt %. But the person of ordinary skill in the art can select other second threshold values, including negative values, depending on measurement and analysis conditions and desirable expandability for a given use.

Another aspect of the present disclosure provides a third method for characterizing an expandable perlite with respect to thermal expansion performance. This method uses a determination of particle size in conjunction with thermogravimetric analysis. The method includes providing a D50 particle size of the sample; determining a third mass loss, the third mass loss being a difference between a stabilized mass of the unexpanded perlite at a third lower temperature that is in the range of 400-550° C. and a stabilized mass of the unexpanded perlite at a third upper temperature of at least 600° C.; and optionally, characterizing the unexpanded perlite as high-expansion perlite if the third mass loss is at least a third threshold value, and the D50 particle size of the sample is at a fourth threshold value.

The third method, as described above, includes determining a third mass loss by comparing stabilized masses at two different temperatures. As used herein, a “stabilized mass” is defined as a mass of the sample after heating (e.g., at a third lower temperature or a third upper temperature) for an amount of time sufficient to arrive at a substantially constant mass (i.e., the mass is stabilized). This will vary depend on sample size and heating conditions, and on the precision of the measurement necessary to provide significant results with respect to the third threshold value. In various embodiments, a substantially constant mass is one that does not change more than 0.05 wt %, e.g., more than 0.02 wt % or 0.01 wt %. The person of ordinary skill can select a sufficient heating time to provide a stabilized mass. For example, in various embodiments as otherwise described herein, a stabilized mass at the third lower temperature is determined after heating the unexpanded perlite at the third lower temperature for at least 30 minutes, e.g., at least 60 minutes, or at least 90 minutes. In various embodiments as otherwise described herein, the stabilized mass of the unexpanded perlite at the third upper temperature is determined after heating at the third upper temperature for at least 30 minutes, or at least 60 minutes, or at least 90 minutes. Of course, the person of ordinary skill in the art will appreciate that other heating programs can be used, as long as it results in a stabilized mass at the desired temperature.

The stabilized mass losses may be determined in a number of ways. It can be convenient to use an instrument that is specially configured to provide a thermogravimetric analysis; there are many thermogravimetric analysis instruments available, including those with differential scanning calorimetry functionality. But other methods can be used, for example, by simply weighing samples before and after heating. In various embodiments as otherwise described herein, the method is performed by heating a single portion of unexpanded perlite first until a stabilized mass is achieved at the third lower temperature, and then until a stabilized mass is achieved at the third upper temperature. Alternatively, the method can be performed by heating a first portion of the unexpanded perlite until a stabilized mass is achieved at the third lower temperature, and a second portion of the unexpanded perlite until a stabilized mass is achieved at the third upper temperature.

As used herein, the third mass loss is the difference between a stabilized mass of a sample at a third lower temperature and a stabilized mass loss at a third upper temperature. As described above, the third lower temperature is in the range of 400-550° C. For example, in various embodiments as otherwise described herein, the third lower temperature is in the range of 400-525° C., or 400-500° C., or 400-475° C., or 400-450° C., or 425-550° C., or 425-525° C., or 425-475° C., or 450-550° C., or 450-525° C., or 450-500° C., or 475-550° C., or 475-525° C., or 500-550° C. As described above, the third upper temperature is at least 600° C. For example, in various embodiments, the third upper temperature is at least 650° C., at least 700° C., at least 750° C., at least 800° C., at least 850° C., or at least 900° C. Here, too, the analysis need not be performed at extremely high temperatures, as the useful water will have substantially been lost at lower temperatures. Thus, in various embodiments as otherwise described herein, the third upper temperature is no more than 1700° C., e.g., no more than 1400° C., or no more than 1200° C., or no more than 1000° C.

Without intending to be bound by theory, the inventors surmise that once a stabilized mass is achieved at the third lower temperature, the non-structural water (i.e. Type A and Type B) is purged from the perlite sample, while the structural water (i.e., Type C), which is believed to contribute strongly to expandability, remains in the sample. When mass is stabilized at the third higher temperature, this structural water has also been removed. The difference between stabilized masses can be a measure of this structural water.

However, the present inventors have found that merely the difference between stabilized masses at the third lower and upper temperatures does not provide sufficient predictive power for perlite expansion. The present inventors have found that including consideration of the particle size of the unexpanded perlite can provide a sufficiently predictive model. Without intending to be bound by theory, the inventors believe that the dynamic TGA measurements of the first and second methods adequately address this factor in the measurement itself, while the static measurements in this third embodiment do not sufficiently do so.

As such, this third characterization method also includes providing a D50 particle size of the sample. As used herein, the D50 particle size is the median particle size, i.e., the size of the particle at which 50% of the particles are of larger particle size and 50% are of smaller particle size. Particle size distributions, and thus the D50 value, can be measured by the person of ordinary skill in the art in a variety of ways, for example, by dynamic image analysis methods using an appropriate camera-based instrument, such as CAMSIZER 3D instrument. In this aspect of the disclosure, the person of ordinary skill in the art can use other methods, including laser diffraction.

In various embodiments, the method includes characterizing the unexpanded perlite as a high-expansion perlite if the third mass loss is at least a third threshold value and the D50 particle size of the sample is at least a fourth threshold value. As with the first threshold value and the second threshold value, the person of ordinary skill in the art can select the third threshold value and the fourth threshold value to characterize unexpanded perlite samples as high-expansion perlites based on the measurement details, the end use and the expansion desired therefor.

In various embodiments as otherwise described herein, the third threshold value is at least 0.1 wt %, e.g., at least 0.2 wt %. In various embodiments as otherwise described herein, the third threshold value is at least 0.3 wt %, e.g., at least 0.4 wt %. In various embodiments as otherwise described herein, the third threshold value is at least 0.5 wt %, e.g., at least 0.6 wt %, or at least 0.7 wt %. In various embodiments as otherwise described herein, the third threshold value is no more than 1.5 wt %, e.g., no more than 1 wt %, or no more than 0.8 wt %. For example, in various embodiments as otherwise described herein, the third threshold value is in the range of 0.1-1.5 wt %, e.g., 0.1-1 wt %, or 0.1-0.8 wt %, or 0.2-1.5 wt %, or 0.2-1 wt %, or 0.2-0.8 wt %, or 0.3-1.5 wt %, or 0.3-1 wt %, or 0.3-0.8 wt %, or 0.4-1.5 wt %, or 0.4-1 wt %, or 0.4-0.8 wt %. In various embodiments as otherwise described herein, the third threshold value is in the range of 0.5-1.5 wt %, e.g., 0.5-1 wt %, or 0.5-0.8 wt %, or 0.6-1.5 wt %, or 0.6-1 wt %, or 0.6-0.8 wt %, or 0.7-1.5 wt %, or 0.7-1 wt %.

In various embodiments as otherwise described herein, the fourth threshold value is at least 50 microns, e.g. at least 100 microns, or at least 250 microns, or at least 400 microns. In various embodiments as otherwise described herein, the fourth threshold value is at least 500 microns, e.g., at least 550 microns, or at least 600 microns. In various embodiments as otherwise described herein, the fourth threshold value is at least 700 microns, e.g., at least 800 microns, or at least 900 microns. In various embodiments as otherwise described herein, the fourth threshold value is no more than 5000 microns, e.g., no more than 3000 microns, or no more than 1500 microns, or no more than 1000 microns. For example, in various embodiments as otherwise described herein, the fourth threshold value is in the range of 50-5000 microns, e.g., 50-3000 microns, or 50-1500 microns, or 50-1000 microns, or 100-5000 microns, or 100-3000 microns, or 100-1500 microns, or 100-1000 microns, or 250-5000 microns or 250-3000 microns, or 250-1500 microns, or 250-1000 microns, or 400-5000 microns, or 400-3000 microns, or 400-1500 microns, or 400-1000 microns. In various embodiments as otherwise described herein, the fourth threshold value is in the range of 500-5000 microns, e.g., 500-3000 microns, or 500-1500 microns, or 500-1000 microns, or 550-5000 microns or 550-3000 microns, or 550-1500 microns, or 550-1000 microns, or 600-5000 microns or 600-3000 microns, or 600-1500 microns, or 600-1000 microns. In various embodiments as otherwise described herein, the fourth threshold value is in the range of 700-5000 microns, e.g., 700-3000 microns, or 700-1500 microns, or 700-1000 microns, or 800-5000 microns or 800-3000 microns, or 800-1500 microns, or 900-5000 microns, or 900-3000 microns, or 900-1500 microns.

The present inventors have noted that particle size of the unexpanded perlite can generally correlate with expansion, with larger particle-size materials typically providing higher expandabilities. Accordingly, in various embodiments, the characterization even under the first method (a) and the second method (b) as described herein can include a consideration of particle size. Accordingly, in various embodiments of the first method (a) and the second method (b) as otherwise described herein, the unexpanded perlite is characterized as a high-expansion perlite only if it has a D50 particle size of at least 50 microns. In various embodiments of the first method (a) and the second method (b) as otherwise described herein, the unexpanded perlite is characterized as a high-expansion perlite only if it has a D50 particle size of at least 100 microns, e.g., at least 150 microns. In various embodiments of the first method (a) and the second method (b) as otherwise described herein, the unexpanded perlite is characterized as a high-expansion perlite only if it has a D50 particle size of at least 200 microns, e.g., at least 250 microns. In various embodiments of the first method (a) and the second method (b) as otherwise described herein, the unexpanded perlite is characterized as a high-expansion perlite only if it has a D50 particle size of at least 400 microns, e.g., at least 450 microns. In various embodiments of the first method (a) and the second method (b) as otherwise described herein, the unexpanded perlite is characterized as a high-expansion perlite only if it has a D50 particle size of at least 500 microns, e.g., at least 550 microns, or at least 600 microns. In various embodiments of the first method (a) and the second method (b) as otherwise described herein, the unexpanded perlite is characterized as a high-expansion perlite only if it has a D50 particle size of at least 700 microns, e.g., at least 800 microns, or at least 900 microns. In various embodiments of the first method (a) and the second method (b) as otherwise described herein, the unexpanded perlite is characterized as a high-expansion perlite only if it has a D50 particle size of no more than 3000 microns, e.g., no more than 1500 microns, or no more than 1000 microns. For example, in various embodiments of the first method (a) and the second method (b) as otherwise described herein, the unexpanded perlite is characterized as a high-expansion perlite only if it has a D50 particle size in the range of 50-5000 microns, e.g., 50-3000 microns, or 50-1500 microns, or 50-1000 microns, or 100-5000 microns, or 100-3000 microns, or 100-1500 microns, or 100-1000 microns, or 150-3000 microns, or 150-1500 microns, or 150-1000 microns, or 200-3000 microns, or 200-1500 microns, or 200-1000 microns, or 250-5000 microns or 250-3000 microns, or 250-1500 microns, or 250-1000 microns, or 400-5000 microns, or 400-3000 microns, or 400-1500 microns, or 400-1000 microns. In various embodiments as otherwise described herein, the unexpanded perlite is characterized as a high-expansion perlite only if it has a D50 particle size in the range of 500-5000 microns, e.g., 500-3000 microns, or 500-1500 microns, or 500-1000 microns, or 550-5000 microns or 550-3000 microns, or 550-1500 microns, or 550-1000 microns, or 600-5000 microns or 600-3000 microns, or 600-1500 microns, or 600-1000 microns. In various embodiments as otherwise described herein, the unexpanded perlite is characterized as a high-expansion perlite only if it has a D50 particle size in the range of 700-5000 microns, e.g., 700-3000 microns, or 700-1500 microns, or 700-1000 microns, or 800-5000 microns or 800-3000 microns, or 800-1500 microns, or 900-5000 microns, or 900-3000 microns, or 900-1500 microns.

The characterization methods described herein can be used to select unexpanded perlites for use in a variety of products and processes. Accordingly, in various embodiments, a method for preparing a product can include characterizing an unexpanded perlite as a high-expansion perlite via a characterization method as described herein; and including the unexpanded perlite in the product. For example, including the unexpanded perlite in the product can comprise including the unexpanded perlite in an unset plaster composition, and allowing the unset plaster composition to set.

The present inventors have used the characterization methods described herein to identify certain unexpanded perlites that are especially useful in certain products. Various of these products and processes for making them are described below. The characterization methods described herein can optionally be used to identify and select unexpanded perlites for use in these products. But the present disclosure contemplates use of such unexpanded perlites in these products and processes regardless of whether they are identified and selected using the methods described herein.

### Fire-Resistant Building Board & Methods of Making the Same

The present inventors have determined that high expansion perlites may be suitable to include in gypsum products, including building boards, to improve their fire-resistance.

Accordingly, another aspect of the present disclosure provides a fire-resistant building board comprising a set gypsum core having a first major surface and a second, opposing major surface, wherein the set gypsum core comprises (preferably, is) a fire-resistant set gypsum material as defined herein. More particularly, the present disclosure provides a fire-resistant building board comprising a set gypsum core having a first major surface and a second, opposing major surface, wherein the set gypsum core comprises a set body of calcium sulfate dihydrate; and an unexpanded perlite dispersed in the set body of calcium sulfate dihydrate. As described above, the present inventors have found that the inclusion of unexpanded perlite with certain characteristics can provide improved fire resistance to the building board. As such, the unexpanded perlite can advantageously have one or more of the following characteristics, when characterized using the methods described herein:
(a) a first mass loss of at least a first threshold value, the first threshold value being at least 0.7 wt %, the first mass loss being determined by subjecting the unexpanded perlite to thermogravimetric analysis (TGA) at a first heating rate of 20° C./minute over a first temperature range from a first lower limit of 600° C. to a first upper limit of 800° C. and determining as the first mass loss the mass lost over the first temperature range;
(b) a second mass loss of at least a second threshold value, the second threshold value being at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
(c)
   (i) a third mass loss of at least a third threshold value, the third threshold value being at least 0.45 wt %, the third mass loss being a difference between a stabilized mass of the unexpanded perlite at a third lower temperature of 500° C. and a stabilized mass of the sample at a third upper temperature that is 1000° C.; and
   (ii) a D50 particle size of at least a fourth threshold value, the fourth threshold value being 400 microns.

In various embodiments as otherwise described herein, the unexpanded perlite has (a) a first mass loss of at least a first threshold value, the first threshold value being at least 0.7 wt %, the first mass loss being determined by subjecting the unexpanded perlite to thermogravimetric analysis (TGA) at a first heating rate of 20° C./minute over a first temperature range from a first lower limit of 600° C. to a first upper limit of 800° C. and determining as the first mass loss the mass lost over the first temperature range. In various embodiments as otherwise described herein, the first threshold value is at least 0.75 wt %, e.g., at least 0.8 wt %. In various embodiments as otherwise described herein, the unexpanded perlite has a first mass loss of no more than 5 wt %, e.g., no more than 3 wt %, or no more than 2 wt %. In various embodiments as otherwise described herein, the unexpanded perlite has a first mass loss of no more than 1.5 wt %, e.g., no more than 1.2 wt %, or no more than 1 wt %.

In various embodiments as otherwise described herein, the unexpanded perlite has (b) a second mass loss of at least a second threshold value, the second threshold value being at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit. For example, in various embodiments as otherwise described herein, the second threshold value is at least 0.05 wt %, e.g., at least 0.06 wt %. In various embodiments as otherwise described herein, the second threshold value is at least 0.07 wt %, e.g., at least 0.08 wt %. In various embodiments as otherwise described herein, the second threshold value is at least 0.1 wt %, e.g., at least 0.15 wt %. In various embodiments as otherwise described herein, the unexpanded perlite has a second mass loss of no more than 5 wt %, e.g., no more than 3 wt %, or no more than 2 wt %. In various embodiments as otherwise described herein, the unexpanded perlite has a second mass loss of no more than 1.5 wt %, e.g., no more than 1 wt %, or no more than 0.7 wt %.

In various embodiments as otherwise described herein, the unexpanded perlite has (c) (i) a third mass loss of at least a third threshold value, the third threshold value being at least 0.45 wt %, the third mass loss being a difference between a stabilized mass of the unexpanded perlite at a third lower temperature of 500° C. and a stabilized mass of the sample at a third upper temperature that is 1000° C.; and (ii) a D50 particle size of at least a fourth threshold value, the fourth threshold value being 400 microns. For example, in various embodiments as otherwise described herein, the third threshold value is at least 0.5 wt %, or is at least 0.55 wt %. In various embodiments as otherwise described herein, the unexpanded perlite has a third mass loss of no more than 5 wt %, e.g., no more than 3 wt %, or no more than 2 wt %. In various embodiments as otherwise described herein, the unexpanded perlite has a third mass loss of no more than 1.5 wt %, e.g., no more than 1 wt %, or no more than 0.8 wt %. In various embodiments as otherwise described herein, the fourth threshold value is at least 500 microns, e.g., at least 600 microns. In various embodiments as otherwise described herein, the fourth threshold value is at least 700 microns, e.g., at least 800 microns. In various embodiments as otherwise described herein, the unexpanded perlite has a D50 particle size or no more than 5000 microns, e.g., no more than 3500 microns. In various embodiments as otherwise described herein, the unexpanded perlite has a D50 particle size or no more than 2500 microns, e.g., no more than 1500 microns. In this aspect of the disclosure, theT D50 value is measured by dynamic image analysis methods using an appropriate camera-based instrument, such as CAMSIZER 3D instrument.

The unexpanded perlite included in the fire-resistant building board may have one or more of the (a), (b), and (c) characteristics as described herein. For example, the unexpanded perlite may have two or more of the (a), (b), and (c) characteristics, as described herein. For example, the unexpanded perlite may have both (a) and (b) characteristics, or both (a) and (c) characteristics, or both (b) and (c) characteristics. In various embodiments as otherwise described herein, the unexpanded perlite has all three of (a), (b), and (c) characteristics as described herein.

Unexpanded perlite can be isolated from a gypsum material such as the material of a building board by isolating the gypsum material from other components (e.g., liners) and dissolving the gypsum matrix to retrieve the non-soluble perlite. For example, unexpanded perlite can be isolated from a gypsum material such as the material of a building board by isolating the gypsum material from other components (e.g., liners) and dissolving the gypsum matrix to retrieve the non-soluble perlite. This dissolution step can, for example, be performed in aqueous systems like water or aqueous ammonium acetate, which can be heated (e.g., at about 60° C., to accelerate the process). The solid residues can then be collected, separated and sieved with sieves of variable mesh size, e.g., to isolate perlite from other components like glass fibers. The isolated perlite can be analyzed as described herein.

Relevant to the fire performance of an unexpanded perlite is its 850° C. thermal expansion. As used herein, thermal expansion is a measurement of the change in volume of an unexpanded perlite sample after being heated at a temperature of 850° C. To measure the 850° C. expansion, a muffle furnace is first pre-heated to 850° C. Then, an unexpanded perlite sample (approximately 3 g) is placed in a metallic (e.g. nickel or platinum) cup crucible and inserted in the already-hot furnace for 1 hour. The samples are then removed from the furnace while the temperature is still at 850° C. or after cooling down to room temperature. The volume of the perlite is measured before and after heating in a graduated glass cylinder. The change in volume (i.e., thermal expansion at 850° C.) may then be calculated as a percent increase with respect to the volume of the unexpanded perlite sample before heating. The present inventors have noted that perlites with high thermal expansion can compensate the high-temperature shrinkage of the plasterboards and help maintain a fire-proof partition. And as described above, the present inventors have found that the characterization methods described herein provide good predictive power with respect to the amount of expansion of the perlite, with materials characterized as high expansion perlites providing better fire-resistance performance. In various embodiments, the unexpanded perlite has an 850° C. thermal expansion of at least 90%, e.g., at least 95%. In various embodiments as otherwise described herein, the unexpanded perlite has an 850° C. thermal expansion of at least 100%, e.g., at least 120%. In various embodiments as otherwise described herein, the unexpanded perlite has an 850° C. thermal expansion of at least 140%, e.g., at least 160%. In various embodiments as otherwise described herein, the unexpanded perlite has an 850° C. thermal expansion of at least 180%, e.g., at least 200%. In various embodiments as otherwise described herein, the unexpanded perlite has an 850° C. thermal expansion of no more than 350%, e.g., no more than 300%. In various embodiments as otherwise described herein, the unexpanded perlite has an 850° C. thermal expansion of no more than 275%, e.g., no more than 250%. In various embodiments as otherwise described herein, the unexpanded perlite has an 850° C. thermal expansion in the range of 90% to 350% (e.g., in the range of 125% to 350%, or 150 to 350%, or 90% to 300%, or 125% to 300%, or 150% to 300%).

As described above, the unexpanded perlite is dispersed in the set body of the calcium sulfate dihydrate. For example, in some embodiments, the unexpanded perlite is substantially dispersed throughout the set body of the calcium sulfate dihydrate. Accordingly, in some embodiments of the disclosure as described herein, the unexpanded perlite concentration in the center of the set body is at least 75% of the concentration within 10% of an outer edge of the set body. For example, in various embodiments, the unexpanded perlite concentration in the center of the set body is at least 80%, at least 85%, at least 90%, or at least 95% of the concentration within 10% of an outer edge of the set body. In some embodiments, the unexpanded perlite concentration in the center of the set body is at least 75% of the concentration at the edge of the set body. In various embodiments, the unexpanded perlite concentration in the center of the gypsum core is at least 80%, at least 85%, at least 90%, or at least 95% of the concentration at the edge of the set body.

The unexpanded perlite can be present in the set gypsum core in a variety of amounts. In various embodiments as otherwise described herein, the unexpanded perlite is present in an amount of at least 0.5 wt %, based on the weight of the set gypsum core. For example, in various embodiments as otherwise described herein, the unexpanded perlite is present in an amount of at least 1 wt %, e.g., at least 2 wt %, based on the weight of the set gypsum core. In various embodiments, the unexpanded perlite is present in an amount of no more than 20 wt %, based on the weight of the set gypsum core, e.g., no more than 18 wt %, or no more than 15 wt %. In various embodiments as otherwise described herein, the unexpanded perlite is present in an amount of no more than 10 wt %, based on the weight of the set gypsum core, e.g., no more than 8 wt %, or no more than 6 wt %, or no more than 4 wt %. In various embodiments as otherwise described herein, the unexpanded perlite is present in an amount in the range of 0.5-10 wt %, e.g., 0.5-8 wt %, or 0.5-6 wt %, or 0.5-4 wt %, based on the weight of the set gypsum core. In various embodiments as otherwise described herein, the unexpanded perlite is present in an amount in the range of 1-10 wt %, e.g., 1-8 wt %, or 1-6 wt %, or 1-4 wt %, based on the weight of the set gypsum core. In various embodiments as otherwise described herein, the unexpanded perlite is present in an amount in the range of 2-10 wt %, or 2-8 wt %, or 2-6 wt %, based on the weight of the set gypsum core.

As described above, the fire-resistant board comprises a gypsum core. Such a core can be provided from a calcium sulfate slurry comprising stucco and water. The stucco is desirably present in the calcium sulfate slurry to provide a gypsum core comprising mostly gypsum. For example, in various embodiments, the gypsum core comprise at least at least 80 wt % gypsum, or at least 85 wt % gypsum, or at least 90 wt % gypsum. As is known in the art, stucco can have a variety of compositions depending on the source and application at hand. As used herein, a “stucco” is a material having at least 75 wt % of calcium sulfate hemihydrate. It is typically provided by calcining gypsum to convert the dihydrate of gypsum to hemihydrate. Real-world samples of stucco typically include, together with the hemihydrate (e.g., present as α-calcium sulfate hemihydrate, R-calcium sulfate hemihydrate, or combinations thereof), one or more of calcium sulfate dihydrate, calcium sulfate anhydrate, and inert calcium sulfate.

In various embodiments as otherwise described herein, the set gypsum core does not include other fire-resistant additives. For example, in some embodiments, the set gypsum core does not include a silicate or a silica.

While not described in detail here, one or more additives (e.g., not including other fire-resistant additives) can be provided in the gypsum core of the board. For example, in some embodiments, the additives are selected from one or more accelerators, fluidizers, retarders, dispersants, foaming agents, and glass fibers. In some embodiments, the additives are present in an amount of no more than 10 wt % of the mass of the gypsum core. In various embodiments, the additives are present in an amount of no more than 8 wt % or no more than 5 wt % of the mass of the gypsum core. The person of ordinary skill in the art will use an appropriate set of additives for a desired gypsum core material.

As described above, the building boards described herein are fire-resistant. Fire resistance is commonly characterized by reduced shrinking of the building board at high temperature. Accordingly, in various embodiments as otherwise described herein, the building board has a board shrinkage of no more than 5%. For example, in various embodiments, the building boards has a board shrinkage of no more than 3% or no more than 2.5%. In various embodiments as otherwise described herein, the building board has a fire resistance that exceeds the 1 hour target set for in ANSI/UL 263 testing criteria.

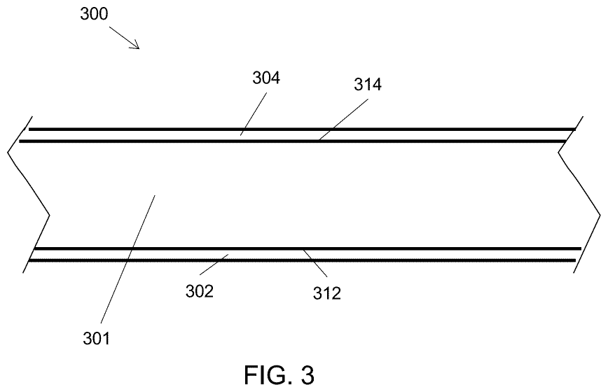

As the person of ordinary skill in the art will appreciate, gypsum boards are typically provided with liners at opposing major surfaces thereof. In some embodiments of the disclosure as described herein, the set gypsum core of the fire-resistant building board is disposed between a first liner at a first major surface of the building board and a second liner at a second, opposing major surface of the building board. An example of such a gypsum board is shown in a cross-sectional schematic view in FIG. 3. Here, fire-resistant set gypsum board (300) includes a gypsum core (301) and a first liner (302) at a first major surface (312) of the gypsum board; a second liner (304) at a second, opposing major surface (314) of the gypsum board. The liners can be formed, for example, from paper (which itself can be coated with a variety of substances, e.g., wax or silicone) or fiberglass. Of course, other liner materials are possible.

The thickness of the fire-resistant building board is not particularly limited. For example, in some embodiments, the fire-resistant building board has a thickness of at least 0.25 inches. For example, in various embodiments as otherwise described herein, the fire-resistant building board has a thickness in the range of 0.25 inches to 1 inch, or 0.25 to 0.75 inches, or 0.25 to 0.5 inches).

Another aspect of the present disclosure provides a method of making a fire-resistant building board comprising a set gypsum core having a first major surface and a second, opposing major surface. The method includes providing a slurry comprising stucco, water, and unexpanded perlite; allowing the slurry to set to from a wet gypsum core; and drying the wet gypsum core at a temperature in the range of 50-350° C. to provide the set gypsum core. The unexpanded perlite can be, in various embodiments, as described in any one or more of the embodiments above.

As described above, the method as described herein includes providing a slurry comprising, stucco, water, and unexpanded perlite. In some embodiments, the slurry is formed by combining stucco, water, and unexpanded perlite. As the person of ordinary skill in the art will appreciate, the water provides fluidity to the slurry for ease of handling, as well as provides the necessary water for hydration of the hemihydrate to gypsum. The person of ordinary skill in the art will select a desirable ratio of stucco to water. In various embodiments of the present disclosure, the weight ratio of stucco to water in the slurry is no more than 4:1, e.g., no more than 3:1, or no more than 2:1. For example, in various embodiments, the weight ratio of stucco to water is in the range of 4:1 to 4:7, or 4:1 to 2:3, or 4:1 to 1:1, or 3:1 to 1:2, or 3:1 to 4:7, or 3:1 to 2:3, or 3:1 to 1:1, or 2:1 to 1:2, or 2:1 to 4:7, or 2:1 to 2:3, or 2:1 to 1:1. The stucco is desirably present in the calcium sulfate slurry to provide a gypsum core comprising mostly gypsum. For example, in various embodiments, the gypsum core comprises at least 75% gypsum, at least 80 wt % gypsum, or at least 85 wt % gypsum.

The method also includes allowing the calcium sulfate slurry to set to form a set gypsum body. As the person of ordinary skill in the art will appreciate, a calcium sulfate slurry as described herein will set over time to form a set gypsum body. Accelerators or retarders in the slurry can be used to adjust set time. The person of ordinary skill in the art can use conventional board manufacturing lines to form the set gypsum body between the liners as described herein to make building boards.

As described above, the method includes drying the set gypsum body to provide the gypsum core. In some embodiments, drying occurs at a temperature in the range of 50-350° C., or 50-325° C. or 50-300° C. (i.e., measured in the environment above the board during drying, e.g., in a drying oven) to provide the gypsum core. For example, in various embodiments, drying occurs at a temperature in the range of 100-350° C., or 100-325° C., or 100-300° C., or 150-350° C., or 150-325° C., or 150-300° C., or 200-350° C., or 200-325° C., or 200-300° C. Drying may be accomplished with an oven, wherein the oven temperature is in the range of 50-350° C., or 50-325° C., or 50-300° C., or100-350° C., or 100-325° C., or 100-300° C., or 150-350° C., or 150-325° C., or 150-300° C., or 200-350° C., or 200-325° C., or 200-300° C. During the drying step, the temperature of the gypsum core desirably does not exceed 125° C., e.g., does not exceed 120° C., 115° C., 110° C., or 105° C. The person of ordinary skill in the art can use conventional drying methods in practicing the methods and boards of the disclosure.

In various embodiments as otherwise described herein, the method of making a fire-resistant building board further includes selecting the unexpanded perlite via the methods (e.g., the first, second, and/or third characterization methods) as described herein.

Another aspect of the present disclosure provide a fire-resistant building board made by the methods as described herein.

### Fire-Resistant Set Gypsum Materials & Methods of Making the Same

The methods described above for characterizing unexpanded perlites can be used to qualify such perlites as high-expansion perlites. These high expansion perlites may be suitable to include in gypsum materials to improve the fire-resistant properties of the material, e.g., in applications other than as cores of building boards.

Accordingly, another aspect of the present disclosure provides a fire-resistant set gypsum material comprising a set body of calcium sulfate dihydrate; and dispersed in the set body of calcium sulfate dihydrate, an unexpanded perlite. The unexpanded perlite of the fire-resistant set gypsum material may be, in various embodiments, as described in any one or more of the embodiments above for the gypsum core (also called “gypsum core material”) of the building boards described herein. Additionally, the fire-resistant set gypsum material may have a characteristic of any one or more of the embodiment above for the set gypsum core of the building boards as described herein. Reciprocally, the unexpanded perlite of the set gypsum core of the building board may be, in various embodiments, as described in any one or more of the embodiments for the fire-resistant set gypsum material described herein. The set gypsum core of the building board may have a characteristic of any one or more of the embodiments for the fire-resistant set gypsum material.

However, requirements for fire-resistant set gypsum materials may vary from those for building boards. Another aspect of the disclosure provides a fire-resistant set gypsum material comprising
a set body of calcium sulfate dihydrate; and
dispersed in the set body of calcium sulfate dihydrate, an unexpanded perlite, the unexpanded perlite having one or more of
   (a) a first mass loss of at least a first threshold value, the first threshold value being at least 0.1 wt %, the first mass loss being determined by subjecting the unexpanded perlite to thermogravimetric analysis (TGA) at a first heating rate of 20° C./minute over a first temperature range from a first lower limit of 700° C. to a first upper limit of 900° C. and determining as the first mass loss the mass lost over the first temperature range;
   (b) a second mass loss of at least a second threshold value, the second threshold value being at least 0.0 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
   (c)
      (i) a third mass loss of at least a third threshold value, the third threshold value being at least 0.1 wt %, the third mass loss being a difference between a stabilized mass of the unexpanded perlite at a third lower temperature of 500° C. and a stabilized mass of the sample at a third upper temperature that is 1000° C.; and
      (ii) a D50 particle size of at least a fourth threshold value, the fourth threshold value being 50 microns.

In various such embodiments, the unexpanded perlite has (a) a first mass loss of at least a first threshold value, the first threshold value being at least 0.1 wt %, the first mass loss being determined by subjecting the unexpanded perlite to thermogravimetric analysis (TGA) at a first heating rate of 20° C./minute over a first temperature range from a first lower limit of 700° C. to a first upper limit of 900° C. and determining as the first mass loss the mass lost over the first temperature range. In various such embodiments, the first threshold value is at least 0.2 wt %, e.g., at 0.3 wt %, or at least 0.4 wt %. In various such embodiments, the first threshold value is at least 0.5 wt %, e.g., at least 0.6 wt %, or at least 0.7 wt %.

In various such embodiments, the unexpanded perlite has (b) a second mass loss of at least a second threshold value, the second threshold value being at least 0.0 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit. In various such embodiments, the second threshold value is at least 0.01 wt %, e.g. at least 0.04 wt %, for instance at least 0.25 wt %. In various such embodiments, the first threshold value is at least 0.3 wt %, e.g., at least 0.4 wt %.

In various such embodiments, the unexpanded perlite has (c) (i) a third mass loss of at least a third threshold value, the third threshold value being at least 0.1 wt %, the third mass loss being a difference between a stabilized mass of the unexpanded perlite at a third lower temperature of 500° C. and a stabilized mass of the sample at a third upper temperature that is 1000° C.; and (ii) a D50 particle size of at least a fourth threshold value, the fourth threshold value being 50 microns. In various such embodiments, the third threshold value is at least 0.15 wt %, e.g., at 0.2 wt %, or at least 0.25 wt %. In various such embodiments, the third threshold value is at least 0.3 wt %, e.g., at least 0.35 wt %, at least 0.4 wt %, or even at least 0.45 wt %. In various such embodiments, the fourth threshold value is at least 50 microns, e.g. at least 100 microns. In various such embodiments, the fourth threshold value is at least 250 microns, e.g., at least 400 microns, or even at least 500 microns.

In some embodiments, the unexpanded perlite has one or both of:
(b) a second mass loss of at least a second threshold value, the second threshold value being at least 0.0 wt %, preferably at least 0.001 wt %, more preferably at least 0.04 wt %, or even at least 0.07 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit, and
(c) (i) a third mass loss of at least a third threshold value, the third threshold value being at least 0.1 wt %, preferably at least 0.45 wt %, or even at least 0.5 wt %, the third mass loss being a difference between a stabilized mass of the unexpanded perlite at a third lower temperature of 500° C. and a stabilized mass of the sample at a third upper temperature that is 1000° C.; and (ii) a D50 particle size of at least a fourth threshold value, the fourth threshold value being 50 microns, preferably 250 microns, more preferably 400 microns, or even 500 microns; and
preferably, has further a first mass loss of at least a first threshold value, the first threshold value being at least 0.7 wt % (for instance at least 0.75 wt %), the first mass loss being determined by subjecting the unexpanded perlite to thermogravimetric analysis (TGA) at a first heating rate of 20° C./minute over a first temperature range from a first lower limit of 600° C. to a first upper limit of 800° C. and determining as the first mass loss the mass lost over the first temperature range.

The unexpanded perlite can be present in the set gypsum material in a variety of amounts. In various embodiments as otherwise described herein, the unexpanded perlite is present in an amount of at least 0.5 wt %, based on the weight of the set gypsum material. For example, in various embodiments as otherwise described herein, the unexpanded perlite is present in an amount of at least 1 wt %, e.g., at least 2 wt %, based on the weight of the set gypsum material. In various embodiments, the unexpanded perlite is present in an amount of no more than 20 wt %, based on the weight of the set gypsum material, e.g., no more than 18 wt %, or no more than 15 wt %. In various embodiments as otherwise described herein, the unexpanded perlite is present in an amount of no more than 10 wt %, based on the weight of the set gypsum material, e.g., no more than 8 wt %, or no more than 6 wt %, or no more than 4 wt %. In various embodiments as otherwise described herein, the unexpanded perlite is present in an amount in the range of 0.5-10 wt %, e.g., 0.5-8 wt %, or 0.5-6 wt %, or 0.5-4 wt %, based on the weight of the set gypsum material. In various embodiments as otherwise described herein, the unexpanded perlite is present in an amount in the range of 1-10 wt %, e.g., 1-8 wt %, or 1-6 wt %, or 1-4 wt %, based on the weight of the set gypsum material. In various embodiments as otherwise described herein, the unexpanded perlite is present in an amount in the range of 2-10 wt %, or 2-8 wt %, or 2-6 wt %, based on the weight of the set gypsum material.

The fire-resistant set gypsum materials can be otherwise as described with respect to the gypsum materials in the building boards as described herein.

Another aspect of the present disclosure provides a layer of the fire-resistant set gypsum material as described herein. In various embodiments as otherwise described herein, the layer is on a substrate. An example of such a layer is shown in a cross-sectional view in FIG. 3. Here, a coated structure (430) includes a layer of the fire-resistant set gypsum material (432) is on a substrate (430).

In various embodiments as otherwise described herein, the layer has a thickness of at least 500 microns. For example, in various embodiments, the layer has a thickness of at least 1 mm, at least 2 mm, or at least 3 mm. In various embodiments as otherwise described herein, the layer has a thickness of no more than 2 cm. For example, in various embodiments, the layer has a thickness of no more than 1.5 cm, or no more than 1 cm, or no more than 7 mm.

The substrate is not particularly limited. For example, in some embodiments, the substrate is another gypsum material, a plaster material, a ceramic material, a wood material, a mesh (e.g., fabric or metallic), or a fiberglass based material.

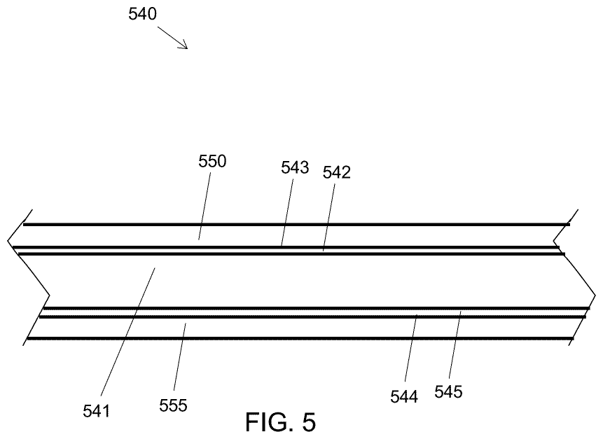

One particular substrate that can be advantageous to coat with the layers described herein is a building board. Accordingly, another aspect of the present disclosure provides a fire-resistant coated building board comprising a building board having a first major surface and a second major surface; and a first layer of fire-resistant set gypsum material as described herein disposed on the first major surface of the building board. In some embodiments, the fire-resistant coated building board further comprises a first layer of fire-resistant set gypsum material as described herein disposed on the second major surface of the building board. An example of such a coated building board is shown in a cross-sectional view in FIG. 5. Here, a coated building board (540) comprising a building board (541) having a first liner (543) disposed at a first major surface (542) and a second liner (545) disposed at a second major surface (544); and a first layer of fire-resistant set gypsum material (550) as described herein disposed on the first major surface (542) of the building board (541). In various embodiments, the coated building board further includes a second layer (551) of fire-resistant set gypsum material as described herein disposed on the second major surface (544) of the building board (540).

Another aspect of the present disclosure provides a method of forming a fire-resistant set gypsum material. The method includes providing a moist composition (e.g., a slurry or paste) comprising stucco, water, and unexpanded perlite; allowing the moist composition to set to from a wet gypsum material; and drying the wet gypsum material at a temperature in the range of 50-350° C. to provide the set gypsum material. The unexpanded perlite may be as described in any one or more of the embodiments above.

As described above, the method as described herein includes providing a moist composition comprising, stucco, water, and unexpanded perlite. In some embodiments, the moist composition is formed by combining stucco, water, and unexpanded perlite. As the person of ordinary skill in the art will appreciate, the water can provide fluidity or workability to the moist composition for ease of handling, as well as provides the necessary water for hydration of the hemihydrate to gypsum. The person of ordinary skill in the art will select a desirable ratio of stucco to water. In various embodiments of the present disclosure, the weight ratio of stucco to water in the moist composition is no more than 4:1, e.g., no more than 3:1, or no more than 2:1. For example, in various embodiments, the weight ratio of stucco to water is in the range of 4:1 to 4:7, or 4:1 to 2:3, or 4:1 to 1:1, or 3:1 to 1:2, or 3:1 to 4:7, or 3:1 to 2:3, or 3:1 to 1:1, or 2:1 to 1:2, or 2:1 to 4:7, or 2:1 to 2:3, or 2:1 to 1:1. But the person of ordinary skill in the art will appreciate that for moist compositions that are more paste-like, less water will be desirable.

The method also includes allowing the moist composition to set to form a wet gypsum material. As the person of ordinary skill in the art will appreciate, the moist composition as described herein will set over time to form a wet gypsum material. Accelerators or retarders in the moist composition can be used to adjust set time.

As described above, the method includes drying the wet gypsum material to provide a set gypsum material. In some embodiments, drying occurs at a temperature in the range of 50-350° C., or 50-325° C. or 50-300° C. (i.e., measured in the environment above the board during drying, e.g., in a drying oven) to provide the gypsum core. For example, in various embodiments, drying occurs at a temperature in the range of 100-350° C., or 100-325° C., or 100-300° C., or 150-350° C., or 150-325° C., or 150-300° C., or 200-350° C., or 200-325° C., or 200-300° C. Drying may be accomplished with an oven, wherein the oven temperature is in the range of 50-350° C., or 50-325° C., or 50-300° C., or 100-350° C., or 100-325° C., or 100-300° C., or 150-350° C., or 150-325° C., or 150-300° C., or 200-350° C., or 200-325° C., or 200-300° C. During the drying step, the temperature of the gypsum core desirably does not exceed 125° C., e.g., does not exceed 120° C., 115° C., 110° C., or 105° C. The person of ordinary skill in the art can use conventional drying methods in practicing the methods and materials of the disclosure.

In various embodiments as otherwise described herein, the method of forming a fire-resistant set gypsum material further includes selecting the unexpanded perlite via the methods (e.g., the first, second, and third characterization methods) as described herein.

Another aspect of the present disclosure provide a fire-resistant set gypsum material made by the methods as described herein.

The present inventors have noted that particle size of the unexpanded perlite can generally correlate with expansion, with larger particle-size materials typically providing higher expandabilities. Accordingly, in various embodiments of the materials, building boards, and methods as otherwise described herein, the unexpanded perlite dispersed in the set body of calcium sulfate dihydrate has a D50 particle size of at least 50 microns. In various embodiments of the materials, building boards, and methods as otherwise described herein, the unexpanded perlite dispersed in the set body of calcium sulfate dihydrate has a D50 particle size of at least 100 microns, e.g., at least 150 microns. In various embodiments of the materials, building boards, and methods as otherwise described herein, the unexpanded perlite dispersed in the set body of calcium sulfate dihydrate has a D50 particle size of at least 200 microns, e.g., at least 250 microns. In various embodiments of the materials, building boards, and methods as otherwise described herein, the unexpanded perlite dispersed in the set body of calcium sulfate dihydrate has a D50 particle size of at least 400 microns, e.g., at least 450 microns. In various embodiments of the materials, building boards, and methods as otherwise described herein, the unexpanded perlite dispersed in the set body of calcium sulfate dihydrate has a D50 particle size of at least 500 microns, e.g., at least 550 microns, or at least 600 microns. In various embodiments of the materials, building boards, and methods as otherwise described herein, the unexpanded perlite dispersed in the set body of calcium sulfate dihydrate has a D50 particle size of at least 700 microns, e.g., at least 800 microns, or at least 900 microns. In various embodiments of the materials, building boards, and methods as otherwise described herein, the unexpanded perlite dispersed in the set body of calcium sulfate dihydrate has a D50 particle size of no more than 3000 microns, e.g., no more than 1500 microns, or no more than 1000 microns. For example, in various embodiments of the materials, building boards, and methods as otherwise described herein, the unexpanded perlite dispersed in the set body of calcium sulfate dihydrate has a D50 particle size in the range of 50-5000 microns, e.g., 50-3000 microns, or 50-1500 microns, or 50-1000 microns, or 100-5000 microns, or 100-3000 microns, or 100-1500 microns, or 100-1000 microns, or 150-3000 microns, or 150-1500 microns, or 150-1000 microns, or 200-3000 microns, or 200-1500 microns, or 200-1000 microns, or 250-5000 microns or 250-3000 microns, or 250-1500 microns, or 250-1000 microns, or 400-5000 microns, or 400-3000 microns, or 400-1500 microns, or 400-1000 microns. In various embodiments of the materials, building boards, and methods as otherwise described herein, the unexpanded perlite dispersed in the set body of calcium sulfate dihydrate has a D50 particle size in the range of 500-5000 microns, e.g., 500-3000 microns, or 500-1500 microns, or 500-1000 microns, or 550-5000 microns or 550-3000 microns, or 550-1500 microns, or 550-1000 microns, or 600-5000 microns or 600-3000 microns, or 600-1500 microns, or 600-1000 microns. In various embodiments of the materials, building boards, and methods as otherwise described herein, the unexpanded perlite dispersed in the set body of calcium sulfate dihydrate has a D50 particle size in the range of 700-5000 microns, e.g., 700-3000 microns, or 700-1500 microns, or 700-1000 microns, or 800-5000 microns or 800-3000 microns, or 800-1500 microns, or 900-5000 microns, or 900-3000 microns, or 900-1500 microns.

The person of ordinary skill in the art will provide the materials and perform the processes described herein based on the general disclosure above, and with reference to the Examples below.

### EXAMPLES

The Examples that follow are illustrative of specific embodiments of the processes of the disclosure, and various uses thereof. They are set forth for explanatory purposes only, and are not to be taken as limiting the scope of the disclosure.

### Example 1. Samples and Experimental Apparatus

### 1.1—Samples

Twenty-nine samples of unexpanded perlite (also known as perlite ore) were sourced from suppliers worldwide. Overall, the grain sizes ranged from D₅₀=233 μm to D₅₀=2729 μm. These samples were measured with the apparatuses and by the characterization methods described in more detail below.

### 1.2—Apparatus

Thermogravimetric Analyses (TGA) were performed with a Mettler Toledo 3+ DSC/TGA on each unexpanded perlite sample described above. The unexpanded perlite was held in a lidded alumina crucible for measurement. Grain size measurements were determined with dynamic image analysis and performed with on a Camsizer (from Microtac Retsch GmbH).

Expansion tests were done in a muffle furnace. To perform the test, the furnace was first pre-heated to 850° C. Then, 3 g of an unexpanded perlite sample were put in a platinum cup crucible and inserted in the already-hot furnace for 1 hour. The samples were then taken out of the furnace after cooling down to room temperature. The volume of the perlite was measured before and after expansion in a graduated glass cylinder to determine the change in volume of the perlite samples.

### Example 2. Characterization Methods of Unexpanded Perlite

### 2.1—First Method

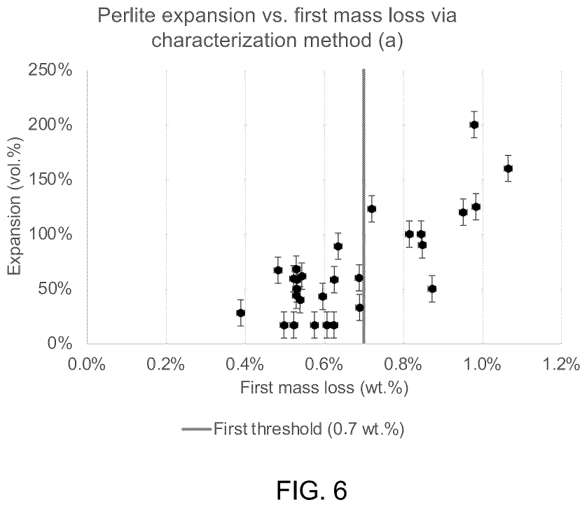

In the first method, the first mass was measured in accordance with the first characterization method (a), as described herein. Specifically, the 28 samples of unexpanded perlite (of Example 1.1) were measured by TGA with a temperature ramp of 20° C./min from 20° C. to 1000° C. The first mass loss was measured between 600° C. and 800° C. Additionally, the thermal expansion of the perlite samples were measured as described above in Example 1.2. The results of the TGA vs. the thermal expansion are plotted in FIG. 6. Unexpanded perlites that have a first mass loss as measured by this first characterization method (a) that is at least than 0.7 wt. % were found to be suitable to achieve at least 100 vol. % expansion at 850° C.

### 2.2—Second Method

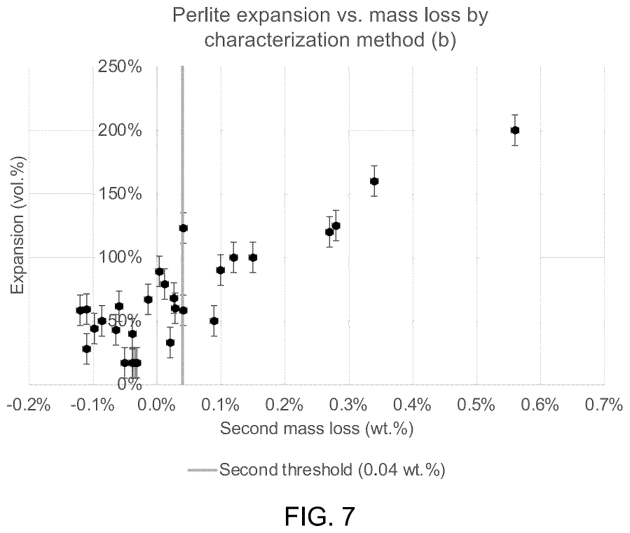

In the second method, the second mass loss was measured in accordance with the second characterization method (b), as described above. Specifically, the 28 samples of perlite of Example 1.1 were measured by TGA with a temperature ramp of 30° C./min from 20° C. to 1000° C. The second mass loss was integrated between 600° C. and 800° C. with a linear background interpolation based on a line extending from the point at 600° C. to the point at 800° C., in the manner shown in FIG. 2. Additionally, the thermal expansion of the perlite samples were measured as described above in Example 1.2. The results of the TGA vs. the thermal expansion are plotted in FIG. 7. Unexpanded perlites that have a measured second mass loss that is at least 0.04 wt. % are shown to be suitable to achieve 100 vol. % expansion at 850° C.

### 2.3—Third Method

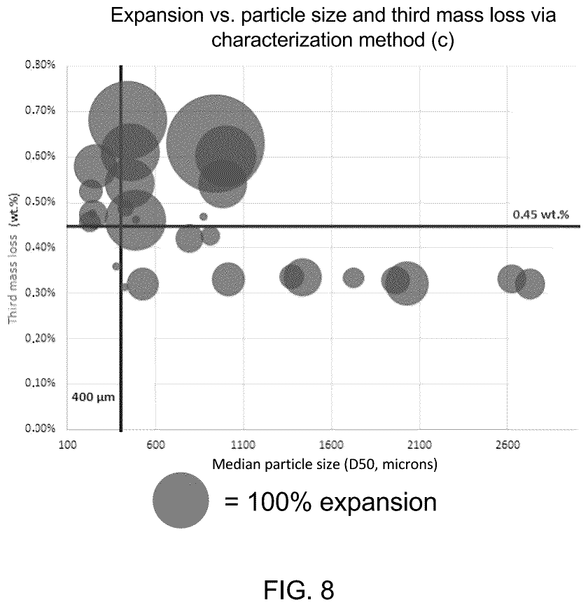

In the third method, the third mass loss was measured in accordance with the third characterization method (c), as described above. Specifically, the 28 samples of perlite of Example 1.1 were measured by TGA with a first heating at 500° C. for two hours, until a stabilized mass was achieved, followed by a second heating to 1000° C. with a ramp of 20° C./min until a stabilized mass was achieved. The third mass loss was calculated as being the mass lost during the second heating phase. Additionally, the thermal expansion and the D50 of the perlite samples were measured as described above in Example 1.2. The results of the TGA, the thermal expansion at 850° C., and the D50 size are plotted In FIG. 8. Circle diameters represent expansion. A 100% expansion circle is shown; the expansion indicated by other circles scales with diameter. Unexpanded perlites that had a third mass loss of at least 0.45 wt % and a median grain size (D50) of at least 400 μm were shown to be suitable to achieve 100 vol. % expansion at 850° C.

While the examples here use different first, second, third and fourth as selection criteria, the person of ordinary skill in the art will appreciate that other such thresholds can be selected by the person of ordinary skill in the art based on the description herein, depending on a particular expandability desired for a particular use.

Various aspects of the disclosure are illustrated by the following enumerated embodiments, which may be combined in any number and in any combination that is not technically or logically inconsistent.

Embodiment 1. A fire-resistant building board comprising a set gypsum core having a first major surface and a second, opposing major surface, wherein the set gypsum core comprises:
a set body of calcium sulfate dihydrate; and
an unexpanded perlite dispersed in the set body of calcium sulfate dihydrate, the unexpanded perlite having one or more of
   (a) a first mass loss of at least a first threshold value, the first threshold value being at least 0.7 wt %, the first mass loss being determined by subjecting the unexpanded perlite to thermogravimetric analysis (TGA) at a first heating rate of 20° C./minute over a first temperature range from a first lower limit of 600° C. to a first upper limit of 800° C. and determining as the first mass loss the mass lost over the first temperature range;
   (b) a second mass loss of at least a second threshold value, the second threshold value being at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
   (c)
      (i) a third mass loss of at least a third threshold value, the third threshold value being at least 0.45 wt %, the third mass loss being a difference between a stabilized mass of the unexpanded perlite at a third lower temperature of 500° C. and a stabilized mass of the sample at a third upper temperature that is 1000° C.; and
      (ii) a D50 particle size of at least a fourth threshold value, the fourth threshold value being 400 microns.

Embodiment 2. The fire-resistant building board of embodiment 1, wherein the unexpanded perlite has (a) a first mass loss of at least a first threshold value, the first threshold value being at least 0.7 wt %, the first mass loss being determined by subjecting the unexpanded perlite to thermogravimetric analysis (TGA) at a first heating rate of 20° C./minute over a first temperature range from a first lower limit of 600° C. to a first upper limit of 800° C. and determining as the first mass loss the mass lost over the first temperature range.

Embodiment 3. The fire-resistant board according to embodiment 1 or embodiment 2, wherein the first threshold value is at least 0.75 wt %.

Embodiment 4. The fire-resistant board according to embodiment 1 or embodiment 2, wherein the first threshold value is at least 0.8 wt %.

Embodiment 5. The fire-resistant board according to any of embodiments 1-3, wherein the unexpanded perlite has a first mass loss of no more than 5 wt %, e.g., no more than 3 wt %, or no more than 2 wt %.

Embodiment 6. The fire-resistant board according to any of embodiments 1-3, wherein the unexpanded perlite has a first mass loss of no more than 1.5 wt %, e.g., no more than 1.2 wt %, or no more than 1 wt %.

Embodiment 7. The fire-resistant board according to any of embodiments 1-6, wherein the unexpanded perlite has (b) a second mass loss of at least a second threshold value, the second threshold value being at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit.

Embodiment 8. The fire-resistant board according to any of embodiments 1-7, wherein the second threshold value is at least 0.05 wt %, e.g., at least 0.06 wt % Embodiment 9. The fire-resistant board according to any of embodiments 1-7, wherein the second threshold value is at least 0.07 wt %, e.g., at least 0.08 wt % Embodiment 10. The fire-resistant board according to any of embodiments 1-7, wherein the second threshold value is at least 0.1 wt %, e.g., at least 0.15 wt % Embodiment 11. The fire-resistant board according to any of embodiments 1-10, wherein the unexpanded perlite has a second mass loss of no more than 5 wt %, e.g., no more than 3 wt %, or no more than 2 wt %.

Embodiment 12. The fire-resistant board according to any of embodiments 1-10, wherein the unexpanded perlite has a second mass loss of no more than 1.5 wt %, e.g., no more than 1 wt %, or no more than 0.7 wt %.

Embodiment 13. The fire-resistant board according to any of embodiments 1-12, wherein the unexpanded perlite has (c) (i) a third mass loss of at least a third threshold value, the third threshold value being at least 0.45 wt %, the third mass loss being a difference between a stabilized mass of the unexpanded perlite at a third lower temperature of 500° C. and a stabilized mass of the sample at a third upper temperature that is 1000° C.; and (ii) a D50 particle size of at least a fourth threshold value, the fourth threshold value being 400 microns.

Embodiment 14. The fire-resistant board according to any of embodiments 1-13, wherein the third threshold value is at least 0.5 wt %.

Embodiment 15. The fire-resistant board according to any of embodiments 1-13, wherein the third threshold value is at least 0.55 wt %.

Embodiment 16. The fire-resistant board according to any of embodiments 1-15, wherein the third mass loss is no more than 5 wt %, e.g., no more than 3 wt %, or no more than 2 wt %.

Embodiment 17. The fire-resistant board according to any of embodiments 1-15, wherein the third mass loss is no more than 1.5 wt %, e.g., no more than 1 wt %, or no more than 0.8 wt %.

Embodiment 18. The fire-resistant board according to any of embodiments 1-17, wherein the fourth threshold value is at least 500 microns.

Embodiment 19. The fire-resistant board according to any of embodiments 1-17, wherein the fourth threshold value is at least 600 microns.

Embodiment 20. The fire-resistant board according to any of embodiments 1-17, wherein the fourth threshold value is at least 700 microns, e.g., at least 800 microns.

Embodiment 21. The fire-resistant board according to any of embodiments 1-20, wherein the unexpanded perlite has a D50 particle size of no more than 5000 microns, e.g., no more than 3500 microns.

Embodiment 22. The fire-resistant board according to any of embodiments 1-20, wherein the unexpanded perlite has a D50 particle size of no more than 2500 microns, e.g., no more than 1500 microns.

Embodiment 23. The fire resistant board according to any of embodiments 1-22, wherein the unexpanded perlite have both (a) and (b) characteristics, or both (a) and (c) characteristics, or both (b) and (c) characteristics.

Embodiment 24. The fire resistant board according to any of embodiments 1-22, wherein the unexpanded perlite has all three of (a), (b) and (c) characteristics.

Embodiment 25. The fire-resistant building board of any of embodiments 1-24, wherein the unexpanded perlite has an 850° C. thermal expansion of at least 90%, e.g., at least 95%.

Embodiment 26. The fire-resistant building board of any of embodiments 1-24, wherein the unexpanded perlite has an 850° C. thermal expansion of at least 100%.

Embodiment 27. The fire-resistant building board of any of embodiments 1-24, wherein the unexpanded perlite has an 850° C. thermal expansion of at least 120%.

Embodiment 28. The fire-resistant building board of any of embodiments 1-24, wherein the unexpanded perlite has an 850° C. thermal expansion of at least 140%, e.g., at least 160%.

Embodiment 29. The fire-resistant building board of any of embodiments 1-24, wherein the unexpanded perlite has an 850° C. thermal expansion of at least 180%, e.g., at least 200%.

Embodiment 30. The fire-resistant building board of any of embodiments 1-29, wherein the unexpanded perlite has an 850° C. thermal expansion of no more than 350%, e.g., no more than 300%.

Embodiment 31. The fire-resistant building board of any of embodiments 1-29, wherein the unexpanded perlite has an 850° C. thermal expansion of no more than 275%, e.g., no more than 250%.

Embodiment 32. The fire-resistant building board of any of embodiments 1-31, wherein the unexpanded perlite is substantially dispersed throughout the set body of calcium sulfate dihydrate.

Embodiment 33. The fire-resistant building board of any of embodiments 1-32, wherein the unexpanded perlite is present in an amount of at least 0.5 wt %, based on the weight of the set gypsum core.

Embodiment 34. The fire-resistant building board of any of embodiments 1-32, wherein the unexpanded perlite is present in an amount of at least 1 wt %, based on the weight of the set gypsum core.

Embodiment 35. The fire-resistant building board of any of embodiments 1-32, wherein the unexpanded perlite is present in an amount of at least 2 wt %, based on the weight of the set gypsum core.

Embodiment 36. The fire-resistant building board of any of embodiments 1-35, wherein the unexpanded perlite is present in an amount of no more than 20 wt %, based on the weight of the set gypsum core, e.g., no more than 18 wt %, or no more than 15 wt %.

Embodiment 37. The fire-resistant building board of any of embodiments 1-35, wherein the unexpanded perlite is present in an amount of no more than 10 wt %, based on the weight of the set gypsum core, e.g., no more than 8 wt %.

Embodiment 38. The fire-resistant building board of any of embodiments 1-35, wherein the unexpanded perlite is present in an amount of no more than 6 wt %, based on the weight of the set gypsum core, e.g., no more than 4 wt %.

Embodiment 39. The fire-resistant building board of any of embodiments 1-32, wherein the unexpanded perlite is present in an amount in the range of 0.5-10 wt % (e.g., in the range of 0.5-8 wt %, or 0.5-6 wt %, or 0.5-4 wt %).

Embodiment 40. The fire-resistant building board of any of embodiments 1-32, wherein the unexpanded perlite is present in an amount in the range of 1-10 wt % (e.g., in the range of 1-8 wt %, or 1-6 wt %, or 1-4 wt %).

Embodiment 41. The fire-resistant building board of any of embodiments 1-32, wherein the unexpanded perlite is present in an amount in the range of 2-10 wt % (e.g., in the range of 2-8 wt %, or 2-6 wt %).

Embodiment 42. The fire-resistant building board of any of embodiments 1-41, wherein the set gypsum core comprises at least 80 wt % gypsum, e.g., at least 85 wt % gypsum, or at least 90 wt % gypsum.

Embodiment 43. The fire-resistant building board of any of embodiments 1-42, wherein the set gypsum core does not include a silicate or a silica.

Embodiment 44. The fire-resistant building board of any of embodiments 1-43, wherein the set gypsum core further comprises one or more of accelerators, fluidizers, retarders, dispersants, foaming agents, and glass fibers.

Embodiment 45. The fire-resistant building board of any of embodiments 1-44, wherein the building board has a board shrinkage of no more than 5% (e.g., no more than 3%, or no more than 2.5 wt %).

Embodiment 46. The fire-resistant building board of any of embodiments 1-45, wherein the building board has a fire resistance that exceeds the 1 hour target set forth in the ANSI/UL 263 testing criteria.

Embodiment 47. The fire-resistant building board of any of embodiments 1-46, wherein the set gypsum core is disposed between a first liner at a first major surface of the building board and a second liner at a second, opposing major surface of the building board.

Embodiment 48. The fire-resistant building board of embodiment 47, wherein the liners are paper liners.

Embodiment 49. The fire-resistant building board of any of embodiments 1-48 having a thickness of at least 0.25 inches.

Embodiment 50. The fire-resistant building board of any of embodiments 1-49 having a thickness in the range of 0.25 inches to 1 inch (e.g., in the range of 0.25-0.75 inches, or 0.25-0.5 inches).

Embodiment 51. A method of forming a fire-resistant building board comprising a set gypsum core having a first major surface and a second, opposing major surface, the method comprising:
providing a slurry comprising stucco, water, and unexpanded perlite;
allowing the slurry to set to form a wet gypsum core; and
drying the wet gypsum core at a temperature in the range of 50-350° C. to provide the set gypsum core,
wherein the unexpanded perlite has one or more of
   (a) a first mass loss of at least a first threshold value, the first threshold value being at least 0.7 wt %, the first mass loss being determined by subjecting the unexpanded perlite to thermogravimetric analysis (TGA) at a first heating rate of 20° C./minute over a first temperature range from a first lower limit of 600° C. to a first upper limit of 800° C. and determining as the first mass loss the mass lost over the first temperature range;
   (b) a second mass loss of at least a second threshold value, the second threshold value being at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
   (c)
      (i) a third mass loss of at least a third threshold value, the third threshold value being at least 0.45 wt %, the third mass loss being a difference between a stabilized mass of the unexpanded perlite at a third lower temperature of 500° C. and a stabilized mass of the sample at a third upper temperature that is 1000° C.; and
      (ii) a D50 particle size of at least a fourth threshold value, the fourth threshold value being 400 microns.

Embodiment 52. The method of embodiment 51, wherein the unexpanded perlite is as described in any one or more of embodiments 2-31.

Embodiment 53. The method of embodiment 51 or embodiment 52, wherein the weight ratio of stucco to water is no more than 4:1 (e.g., no more than 3:1, or no more than 2:1).

Embodiment 54. The method of embodiment 51 or embodiment 52, wherein the weight ratio of stucco to water is in the range of 4:1 to 1:2 (e.g., in the range of 4:1 to 4:7, or 4:1 to 2:3, or 4:1 to 1:1, or 3:1 to 1:2, or 3:1 to 4:7, or 3:1 to 2:3, or 3:1 to 1:1, or 2:1 to 1:2, or 2:1 to 4:7, or 2:1 to 2:3, or 2:1 to 1:1).

Embodiment 55. The method of any of embodiments 51-54, wherein the drying occurs at a temperature in the range of 50-325° C. (e.g., in the range of 50-300° C.).

Embodiment 56. The method of any of embodiments 51-54, wherein the drying occurs at a temperature in the range of 100-350° C. (e.g., in the range of 100-325° C. or 100-300° C.).

Embodiment 57. The method of any of embodiments 51-54, wherein the drying occurs at a temperature in the range of 150-350° C. (e.g., in the range of 150-325° C. or 150-300° C.).

Embodiment 58. The method of any of embodiments 51-54, wherein the drying occurs at a temperature in the range of 200-350° C. (e.g., in the range of 200-325° C., or 200-300° C.).

Embodiment 59. The method of any of embodiments 51-58, wherein the building board is as described in any of embodiments 32-50.

Embodiment 60. A fire-resistant building board made by the method of any of embodiments 51-59.

Embodiment 61. A fire-resistant set gypsum material comprising a set body of calcium sulfate dihydrate; and dispersed in the set body of calcium sulfate dihydrate, an unexpanded perlite, the unexpanded perlite having one or more of
(a) a first mass loss of at least a first threshold value, the first threshold value being at least 0.1 wt %, the first mass loss being determined by subjecting the unexpanded perlite to thermogravimetric analysis (TGA) at a first heating rate of 20° C./minute over a first temperature range from a first lower limit of 700° C. to a first upper limit of 900° C. and determining as the first mass loss the mass lost over the first temperature range;
(b) a second mass loss of at least a second threshold value, the second threshold value being at least 0.0 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
(c)
   (i) a third mass loss of at least a third threshold value, the third threshold value being at least 0.1 wt %, the third mass loss being a difference between a stabilized mass of the unexpanded perlite at a third lower temperature of 500° C. and a stabilized mass of the sample at a third upper temperature that is 1000° C.; and
   (ii) a D50 particle size of at least a fourth threshold value, the fourth threshold value being 50 microns.

Embodiment 62. The fire-resistant set gypsum material of embodiment 61, wherein the unexpanded perlite is as described in any one or more of embodiments 2-31.

Embodiment 63. The fire-resistant set gypsum material of embodiment 61 or 62, wherein the unexpanded perlite has
(a) a first mass loss of at least a first threshold value, the first threshold value being at least 0.1 wt %, the first mass loss being determined by subjecting the unexpanded perlite to thermogravimetric analysis (TGA) at a first heating rate of 20° C./minute over a first temperature range from a first lower limit of 700° C. to a first upper limit of 900° C. and determining as the first mass loss the mass lost over the first temperature range;

Embodiment 64. The fire-resistant set gypsum material of embodiment 63, wherein the first threshold value is at least 0.2 wt %, e.g., at 0.3 wt %, or at least 0.4 wt %.

Embodiment 65. The fire-resistant set gypsum material of embodiment 63, wherein the first threshold value is at least 0.5 wt %, e.g., at least 0.6 wt %, or at least 0.7 wt %.

Embodiment 66. The fire-resistant set gypsum material of any of embodiments 61-65, wherein the unexpanded perlite has
(b) a second mass loss of at least a second threshold value, the second threshold value being at least 0.0 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; Embodiment 67. The fire-resistant set gypsum material of embodiment 66, wherein the second threshold value is at least 0.05 wt %, e.g., at 0.1 wt %, or at least 0.2 wt %.

Embodiment 68. The fire-resistant set gypsum material of embodiment 66, wherein the first threshold value is at least 0.3 wt %, e.g., at least 0.4 wt %.

Embodiment 69. The fire-resistant set gypsum material of any of embodiments 61-68, wherein the unexpanded perlite has
(c)
   (i) a third mass loss of at least a third threshold value, the third threshold value being at least 0.1 wt %, the third mass loss being a difference between a stabilized mass of the unexpanded perlite at a third lower temperature of 500° C. and a stabilized mass of the sample at a third upper temperature that is 1000° C.; and
   (ii) a D50 particle size of at least a fourth threshold value, the fourth threshold value being 50 microns.

Embodiment 70. The fire-resistant set gypsum material of embodiment 69, wherein the third threshold value is at least 0.15 wt %, e.g., at 0.2 wt %, or at least 0.25 wt %.

Embodiment 71. The fire-resistant set gypsum material of embodiment 69, wherein the third threshold value is at least 0.3 wt %, e.g., at least 0.35 wt %, or at least 0.4 wt %.

Embodiment 72 The fire-resistant set gypsum material of any of embodiments 69-71,
wherein fourth threshold value is at least 50 microns, e.g. at least 100 microns.

Embodiment 73. The fire-resistant set gypsum material of any of embodiments 69-71,
wherein the fourth threshold value is at least 250 microns, e.g., at least 400 microns.

Embodiment 74. The fire-resistant set gypsum material of any of embodiments 61-73, having a characteristic recited in any one or more of embodiments 32-44 for the set gypsum core.

Embodiment 75. A layer of fire-resistant set gypsum material of any of embodiments 61-74, in the form of a layer on a substrate.

Embodiment 76. The layer of fire-resistant set gypsum material of embodiment 75,
wherein the layer has a thickness of at least 500 microns, e.g., at least 1 mm.

Embodiment 77. The layer of fire-resistant set gypsum material of embodiment 75,
wherein the layer has a thickness of at least 2 mm, e.g., at least 3 mm.

Embodiment 78. The layer of fire-resistant set gypsum material of any of embodiments 75-77, wherein the layer has a thickness of no more than 2 cm, e.g., no more than 1.5 cm.

Embodiment 79. The layer of fire-resistant set gypsum material of any of embodiments 75-77, wherein the layer has a thickness of no more than 1 cm, e.g., no more than 7 mm.

Embodiment 80. A coated building board comprising a building board having a first major surface and a second major surface; and a first layer of the fire-resistant set gypsum material of any of embodiments 75-79 disposed on the first major surface of the building board.

Embodiment 81. A coated building board of embodiment 69, further comprising a second layer of the fire-resistant set gypsum material of any of embodiments 75-79 disposed on the second major surface of the building board.

Embodiment 82. A coated building board of embodiment 69, lacking a second layer of the fire-resistant set gypsum material of any of embodiments 75-79 disposed on the second major surface of the building board.

Embodiment 83. A method of making a fire-resistant set gypsum material, the method comprising:
providing a moist composition comprising stucco, water, and unexpanded perlite;
allowing the moist composition to set to from a wet gypsum material; and
drying the wet gypsum material at a temperature in the range of 50-350° C. to provide the set gypsum material,
wherein the unexpanded perlite has one or more of
   (a) a first mass loss of at least a first threshold value, the first threshold value being at least 0.1 wt %, the first mass loss being determined by subjecting the unexpanded perlite to thermogravimetric analysis (TGA) at a first heating rate of 20° C./minute over a first temperature range from a first lower limit of 600° C. to a first upper limit of 800° C. and determining as the first mass loss the mass lost over the first temperature range;
   (b) a second mass loss of at least a second threshold value, the second threshold value being at least 0.0 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
   (c)
      (i) a third mass loss of at least a third threshold value, the third threshold value being at least 0.1 wt %, the third mass loss being a difference between a stabilized mass of the unexpanded perlite at a third lower temperature of 500° C. and a stabilized mass of the sample at a third upper temperature that is 1000° C.; and
      (ii) a D50 particle size of at least a fourth threshold value, the fourth threshold value being 50 microns.

Embodiment 84. The method of embodiment 83, wherein the unexpanded perlite is as described in any one or more of embodiments 2-31 or 63-73.

Embodiment 85. The method of embodiment 83 or embodiment 84, wherein the weight ratio of stucco to water in the moistened composition is no more than 4:1 (e.g., no more than 3:1, or no more than 2:1).

Embodiment 86. The method of embodiment 83 or embodiment 84, wherein the weight ratio of stucco to water in the moistened composition is in the range of 4:1 to 1:2 (e.g., in the range of 4:1 to 4:7, or 4:1 to 2:3, or 4:1 to 1:1, or 3:1 to 1:2, or 3:1 to 4:7, or 3:1 to 2:3, or 3:1 to 1:1, or 2:1 to 1:2, or 2:1 to 4:7, or 2:1 to 2:3, or 2:1 to 1:1).

Embodiment 87. The method of any of embodiments 83-86, wherein the drying occurs at a temperature in the range of 50-325° C. (e.g., in the range of 50-300° C.).

Embodiment 88. The method of any of embodiments 83-87, wherein the fire-resistant set gypsum material has a characteristic recited in any one or more of embodiments 32-44 for the set gypsum core.

Embodiment 89. A fire-resistant set gypsum material made by the method of any of embodiments 83-88.

Embodiment 91. The board, material or method of any of embodiments 1-89, wherein the unexpanded perlite dispersed in the set body of calcium sulfate dihydrate has a D50 particle size of at least 50 microns.

Embodiment 92. The board, material or method of any of embodiments 1-89, wherein the unexpanded perlite dispersed in the set body of calcium sulfate dihydrate has a D50 particle size of at least 100 microns, e.g., at least 150 microns.

Embodiment 93. The board, material or method of any of embodiments 1-89, wherein the unexpanded perlite dispersed in the set body of calcium sulfate dihydrate has a D50 particle size of at least 200 microns, e.g., at least 250 microns.

Embodiment 94. The board, material or method of any of embodiments 1-89, wherein the unexpanded perlite dispersed in the set body of calcium sulfate dihydrate has a D50 particle size of at least 400 microns, e.g., at least 450 microns.

Embodiment 95. The board, material or method of any of embodiments 1-89, wherein the unexpanded perlite dispersed in the set body of calcium sulfate dihydrate has a D50 particle size of at least 500 microns, e.g., at least 550 microns, or at least 600 microns.

Embodiment 96. The board, material or method of any of embodiments 1-89, wherein the unexpanded perlite dispersed in the set body of calcium sulfate dihydrate has a D50 particle size of at least 700 microns, e.g., at least 800 microns, or at least 900 microns.

Embodiment 97. The board, material or method of any of embodiments 1-96, wherein the unexpanded perlite dispersed in the set body of calcium sulfate dihydrate has a D50 particle size of no more than 3000 microns, e.g., no more than 1500 microns, or no more than 1000 microns.

Embodiment 98. The board, material or method of any of embodiments 1-89, wherein the unexpanded perlite dispersed in the set body of calcium sulfate dihydrate has a D50 particle size in the range of 50-5000 microns, e.g., 50-3000 microns, or 50-1500 microns, or 50-1000 microns, or 100-5000 microns, or 100-3000 microns, or 100-1500 microns, or 100-1000 microns, or 150-3000 microns, or 150-1500 microns, or 150-1000 microns, or 200-3000 microns, or 200-1500 microns, or 200-1000 microns, or 250-5000 microns or 250-3000 microns, or 250-1500 microns, or 250-1000 microns, or 400-5000 microns, or 400-3000 microns, or 400-1500 microns, or 400-1000 microns.

Embodiment 99. The board, material or method of any of embodiments 1-89, wherein the unexpanded perlite dispersed in the set body of calcium sulfate dihydrate has a D50 particle size in the range of 500-5000 microns, e.g., 500-3000 microns, or 500-1500 microns, or 500-1000 microns, or 550-5000 microns or 550-3000 microns, or 550-1500 microns, or 550-1000 microns, or 600-5000 microns or 600-3000 microns, or 600-1500 microns, or 600-1000 microns.

Embodiment 100. The board, material or method of any of embodiments 1-89, wherein the unexpanded perlite dispersed in the set body of calcium sulfate dihydrate has a D50 particle size in the range of 700-5000 microns, e.g., 700-3000 microns, or 700-1500 microns, or 700-1000 microns, or 800-5000 microns or 800-3000 microns, or 800-1500 microns, or 900-5000 microns, or 900-3000 microns, or 900-1500 microns.

Embodiment 101. A method for characterizing an unexpanded perlite with respect to thermal expansion performance, the method comprising:
subjecting the unexpanded perlite to thermogravimetric analysis (TGA) at a first heating rate of at least 10° C./minute over a first temperature range from a first lower limit of no more than 700° C. to a first upper limit of at least 800° C.;
determining a first mass loss over the first temperature range; and
optionally, characterizing the unexpanded perlite as high-expansion perlite if the first mass loss is at least a first threshold value.

Embodiment 102. The method according to embodiment 101, wherein the first heating rate is at least 15° C./min.

Embodiment 103. The method according to embodiment 101, wherein the first heating rate is at least 20° C./min.

Embodiment 104. The method according to any of embodiments 101-103, wherein the first heating rate is no more than 100° C./min, e.g., no more than 75° C./min, or no more than 50° C./min.

Embodiment 105. The method according to any of embodiments 101-104, wherein the first lower limit is no more than 650° C., e.g., no more than 600° C.

Embodiment 106. The method according to any of embodiments 101-104, wherein the first lower limit is no more than 550° C., e.g., no more than 500° C.

Embodiment 107. The method according to any of embodiments 101-106, wherein the first lower limit is at least 300° C., e.g., at least 350° C., or at least 400° C., or at least 450° C.

Embodiment 108. The method according to any of embodiments 101-106, wherein the first lower limit is at least 500° C., e.g., at least 550° C., or at least 600° C., or at least 650° C.

Embodiment 109. The method according to any of embodiments 101-108, wherein the first upper limit is at least 850° C., e.g., at least 900° C.

Embodiment 110. The method according to any of embodiments 101-109, wherein the first upper limit is no more than 1700° C., e.g., no more than 1400° C., or no more than 1200° C., or no more than 1000° C.

Embodiment 111. The method according to any of embodiments 101-110, wherein the first threshold value is at least 0.01 wt %, e.g., at least 0.05 wt %, or at least 0.1 wt %.

Embodiment 112. The method according to any of embodiments 101-110, wherein the first threshold value is at least 0.2 wt %, e.g., at least 0.3 wt %.

Embodiment 113. The method according to any of embodiments 101-110, wherein the first threshold value is at least 0.4 wt %, e.g., at least 0.5 wt %.

Embodiment 114. The method according to any of embodiments 101-110, wherein the first threshold value is in the range of 0.01-0.6 wt %, e.g., 0.01-0.5 wt %, or 0.01-0.4 wt %, or 0.01-0.3 wt %, or 0.01-0.2 wt %.

Embodiment 115. The method according to any of embodiments 101-110, wherein the first threshold value is in the range of 0.05-0.6 wt %, e.g., 0.05-0.5 wt %, or 0.05-0.4 wt %, or 0.05-0.3 wt %, or 0.05-0.2 wt %.

Embodiment 116. The method according to any of embodiments 101-110, wherein the first threshold value is in the range of 0.1-0.6 wt %, e.g., 0.1-0.5 wt %, or 0.1-0.4 wt %, or 0.1-0.3 wt %.

Embodiment 117. The method according to any of embodiments 101-110, wherein the first threshold value is in the range of 0.2-0.6 wt %, e.g., 0.2-0.5 wt %, or 0.2-0.4 wt %.

Embodiment 118. The method according to any of embodiments 101-110, wherein the first threshold value is in the range of 0.3-0.6 wt %, e.g., 0.3-0.5 wt %, or 0.4-0.6 wt %.

Embodiment 119 The method according to any of embodiments 101-110, wherein the first threshold value is at least 0.6 wt %.

Embodiment 120. The method according to any of embodiments 101-110, wherein the first threshold value is at least 0.7 wt %, e.g., at least 0.75 wt %, or at least 0.8 wt %.

Embodiment 121. The method according to any of embodiments 101-110, wherein the first threshold value is in the range of 0.5-1.5 wt %, e.g., 0.5-1.2 wt %, or 0.5-1 wt %, or 0.6-1.5 wt %, or 0.6-1.2 wt %, or 0.6-1 wt %, or 0.7-1.5 wt %, or 0.7-1.2 wt %, or 0.7-1 wt %, or 0.75-1.5 wt %, or 0.75-1.2 wt %, or 0.75-1 wt %, or 0.8-1.5 wt %, or 0.8-1.2 wt %, or 0.8-1 wt %.

Embodiment 122. A method for characterizing a sample of unexpanded perlite with respect to thermal expansion performance, the method comprising:
subjecting the unexpanded perlite to thermogravimetric analysis (TGA) at a second heating rate of at least 20° C./minute over a second temperature range from a second lower limit of in the range of 500-700° C. to a second upper limit of at least 700° C., the second temperature range covering at least 100° C. in temperature difference;
determining a second mass loss, the second mass loss being an excess mass loss over the second temperature range, the excess mass loss being defined as a mass loss in excess of a mass loss represented by a line interpolated on a graph of mass loss vs. temperature from the second lower limit to the second upper limit; and
optionally, characterizing the unexpanded perlite as high-expansion perlite if the second mass loss is at least a second threshold value.

Embodiment 123. The method according to embodiment 122, wherein the second heating rate is at least 25° C./min.

Embodiment 124. The method according to embodiment 122, wherein the second heating rate is at least 30° C./min.

Embodiment 125. The method according to any of embodiments 122-124, wherein the second heating rate is no more than 100° C./min, e.g., no more than 75° C./min, or no more than 50° C./min.

Embodiment 126. The method according to any of embodiments 122-125, wherein the second lower limit is in the range of 500-650° C., e.g., 500-600° C., or 500-550° C.

Embodiment 127. The method according to any of embodiments 122-125, wherein the second lower limit is in the range of 550-700° C., e.g., 550-650° C., or 550-600° C.

Embodiment 128. The method according to any of embodiments 122-127, wherein the second upper limit is at least 725° C., e.g., at least 750° C.

Embodiment 129. The method according to any of embodiments 122-127, wherein the second upper limit is at least 750° C., e.g., at least 800° C.

Embodiment 130. The method according to any of embodiments 122-129, wherein the second upper limit is no more than 1700° C., e.g., no more than 1400° C., or no more than 1200° C., or no more than 1000° C.

Embodiment 131. The method according to any of embodiments 122-130, wherein the second threshold value is at least 0 wt %, e.g., at least 0.01 wt %, or at least 0.25 wt %.

Embodiment 132. The method according to any of embodiments 122-130, wherein the second threshold value is at least 0.04 wt %, e.g., at least 0.05 wt %, or at least 0.06 wt %.

Embodiment 133. The method according to any of embodiments 122-130, wherein the second threshold value is at least 0.07 wt %, e.g., at least 0.085 wt %.

Embodiment 134. The method according to any of embodiments 122-130, wherein the second threshold value is at least 0.1 wt %, e.g., at least 0.15 wt %, or at least 0 2 wt %.

Embodiment 135. The method according to any of embodiments 122-130, wherein the second threshold value is at least 0.25 wt %, e.g., at least 0.3 wt %.

Embodiment 136. The method according to any of embodiments 122-130, wherein the second threshold value is in the range of 0-1 wt %, e.g., 0-0.6 wt %, or 0-0.4 wt %, or 0-0.2 wt %, or 0-0.1 wt %, or 0.01-1 wt %, or 0.01-0.6 wt %, or 0.01-0.4 wt %, or 0.01-0.2 wt %, or 0.01-0.1 wt %.

Embodiment 137. The method according to any of embodiments 122-130, wherein the second threshold value is in the range of 0.04-1 wt %, e.g., 0.04-0.6 wt %, or 0.04-0.4 wt %, or 0.04-0.2 wt %, or 0.04-0.1 wt %, or 0.05-1 wt %, or 0.05-0.6 wt %, or 0.05-0.4 wt %, or 0.05-0.2 wt %, or 0.05-0.1 wt %, or 0.06-1 wt %, or 0.06-0.6 wt %, or 0.06-0.4 wt %, or 0.06-0.2 wt %, or 0.06-0.1 wt %, or 0.07-1 wt %, or 0.07-0.6 wt %, or 0.07-0.4 wt %, or 0.07-0.2 wt %, or 0.07-0.1 wt %, or 0.08-1 wt %, or 0.08-0.6 wt %, or 0.08-0.4 wt %, or 0.08-0.2 wt %, or 0.08-0.1 wt %.

Embodiment 138. The method according to any of embodiments 122-130, wherein the second threshold value is in the range of 0.1-1 wt %, e.g., 0.1-0.6 wt %, or 0.1-0.4 wt %, or 0.1-0.2 wt %, or 0.1-0.1 wt %, or 0.15-1 wt %, or 0.15-0.6 wt %, or 0.15-0.4 wt %, or 0.2-1 wt %, or 0.2-0.6 wt %, or 0.2-0.4 wt %, or 0.25-1 wt %, or 0.25-0.6 wt %, or 0.25-0.4 wt %, or 0.3-1 wt %, or 0.3-0.6 wt %.

Embodiment 139. The method according to any of embodiments 101-138 wherein the unexpanded perlite is characterized as a high-expansion perlite only if it has a D50 particle size of at least 50 microns.

Embodiment 140. The method according to any of embodiments 101-138 wherein the unexpanded perlite is characterized as a high-expansion perlite only if it has a D50 particle size of at least 100 microns, e.g., at least 150 microns.

Embodiment 141. The method according to any of embodiments 101-138 wherein the unexpanded perlite is characterized as a high-expansion perlite only if it has a D50 particle size of at least 200 microns, e.g., at least 250 microns.

Embodiment 142. The method according to any of embodiments 101-138 wherein the unexpanded perlite is characterized as a high-expansion perlite only if it has a D50 particle size of at least 400 microns, e.g., at least 450 microns.

Embodiment 143. The method according to any of embodiments 101-138 wherein the unexpanded perlite is characterized as a high-expansion perlite only if it has a D50 particle size of at least 500 microns, e.g., at least 550 microns, or at least 600 microns.

Embodiment 144. The method according to any of embodiments 101-138 wherein the unexpanded perlite is characterized as a high-expansion perlite only if it has a D50 particle size of at least 700 microns, e.g., at least 800 microns, or at least 900 microns.

Embodiment 145. The method according to any of embodiments 101-144 wherein the unexpanded perlite is characterized as a high-expansion perlite only if it has a D50 particle size of no more than 3000 microns, e.g., no more than 1500 microns, or no more than 1000 microns.

Embodiment 146. The method according to any of embodiments 101-138 wherein the unexpanded perlite is characterized as a high-expansion perlite only if it has a D50 particle size in the range of 50-5000 microns, e.g., 50-3000 microns, or 50-1500 microns, or 50-1000 microns, or 100-5000 microns, or 100-3000 microns, or 100-1500 microns, or 100-1000 microns, or 150-3000 microns, or 150-1500 microns, or 150-1000 microns, or 200-3000 microns, or 200-1500 microns, or 200-1000 microns, or 250-5000 microns or 250-3000 microns, or 250-1500 microns, or 250-1000 microns, or 400-5000 microns, or 400-3000 microns, or 400-1500 microns, or 400-1000 microns.

Embodiment 147. The method according to any of embodiments 101-138 wherein the unexpanded perlite is characterized as a high-expansion perlite only if it has a D50 particle size in the range of 500-5000 microns, e.g., 500-3000 microns, or 500-1500 microns, or 500-1000 microns, or 550-5000 microns or 550-3000 microns, or 550-1500 microns, or 550-1000 microns, or 600-5000 microns or 600-3000 microns, or 600-1500 microns, or 600-1000 microns.

Embodiment 148. The method according to any of embodiments 101-138 wherein the unexpanded perlite is characterized as a high-expansion perlite only if it has a D50 particle size in the range of 700-5000 microns, e.g., 700-3000 microns, or 700-1500 microns, or 700-1000 microns, or 800-5000 microns or 800-3000 microns, or 800-1500 microns, or 900-5000 microns, or 900-3000 microns, or 900-1500 microns.

Embodiment 149. A method for characterizing an unexpanded perlite with respect to thermal expansion performance, the method comprising:
providing a D50 particle size of the unexpanded perlite;
determining a third mass loss of the unexpanded perlite, the third mass loss being a difference between a stabilized mass of the sample at a third lower temperature that is in the range of 400-550° C. and a stabilized mass of the sample at a third upper temperature of at least 600° C.; and
optionally, characterizing the unexpanded perlite as high-expansion perlite if the third mass loss is at least a third threshold value, and the D50 particle size of the sample is at least a fourth threshold value.

Embodiment 150. The method according to embodiment 149, wherein the third lower temperature is in the range of 400-525° C., or 400-500° C., or 400-475° C., or 400-450° C., or 425-550° C., or 425-525° C., or 425-475° C., or 450-550° C., or 450-525° C., or 450-500° C., or 475-550° C., or 475-525° C., or 500-550° C.

Embodiment 151. The method according to embodiment 149 or embodiment 150, wherein the stabilized mass of the sample at the third lower temperature is determined after heating at the third lower temperature for at least 30 minutes, e.g., at least 60 minutes, or at least 90 minutes.

Embodiment 152. The method according to any of embodiments 149-151, wherein the third upper temperature is at least 650° C., e.g., at least 700° C., or at least 750° C., or at least 800° C., or at least 850° C., or at least 900° C.

Embodiment 153. The method according to any of embodiments 149-152, wherein the third upper temperature is no more than 1700° C., e.g., no more than 1400° C., or no more than 1200° C., or no more than 1000° C.

Embodiment 154. The method according to any of embodiments 149-153, wherein the stabilized mass of the sample at the third upper temperature is determined after heating at the third upper temperature for at least 30 minutes, e.g., at least 60 minutes, or at least 90 minutes.

Embodiment 155. The method according to any of embodiments 149-154, performed by heating a single portion of the unexpanded perlite first until a stabilized mass is achieved at the third lower temperature and then until a stabilized mass is achieved at the third upper temperature.

Embodiment 156. The method according to any of embodiments 149-155, performed by heating a first portion of the unexpanded perlite until a stabilized mass is achieved at the third lower temperature, and heating a second portion of the unexpanded perlite until a stabilized mass is achieved at the third upper temperature.

Embodiment 157. The method according to any of embodiments 149-156, wherein the heating and mass determinations are performed by TGA.

Embodiment 158. The method according to any of embodiments 149-157, wherein the third threshold value is at least 0.1 wt %, e.g., at least 0.2 wt %, or at least 0.3 wt %, e.g., at least 0.4 wt %.

Embodiment 159. The method according to any of embodiments 149-157, wherein the third threshold value is at least 0.5 wt %, e.g., at least 0.6 wt %, e.g., at least 0.7 wt %.

Embodiment 160. The method according to any of embodiments 149-159, wherein the third threshold value is no more than 1.5 wt %, e.g., no more than 1 wt %, or no more than 0.8 wt %.

Embodiment 161. The method according to any of embodiments 149-159, wherein the third threshold value is in the range of 0.1-1.5 wt %, e.g., 0.1-1 wt %, or 0.1-0.8 wt %, or 0.2-1.5 wt %, or 0.2-1 wt %, or 0.2-0.8 wt %, or 0.3-1.5 wt %, or 0.3-1 wt %, or 0.3-0.8 wt %, or 0.4-1.5 wt %, or 0.4-1 wt %, or 0.4-0.8 wt %.

Embodiment 162. The method according to any of embodiments 149-159, wherein the third threshold value is in the range of 0.5-1.5 wt %, e.g., 0.5-1 wt %, or 0.5-0.8 wt %, or 0.6-1.5 wt %, or 0.6-1 wt %, or 0.6-0.8 wt %, or 0.7-1.5 wt %, or 0.7-1 wt %.

Embodiment 163. The method according to any of embodiments 149-162, wherein the fourth threshold value is at least 50 microns, e.g., at least 100 microns.

Embodiment 164. The method according to any of embodiments 149-162, wherein the fourth threshold value is at least 250 microns, e.g., at least 400 microns.

Embodiment 165. The method according to any of embodiments 149-162, wherein the fourth threshold value is at least 500 microns, e.g., at least 550 microns, or at least 600 microns.

Embodiment 166. The method according to any of embodiments 149-162, wherein the fourth threshold value is at least 700 microns, e.g., at least 800 microns, or at least 900 microns.

Embodiment 167. The method according to any of embodiments 149-166, wherein the fourth threshold value is no more than 5000 microns, e.g., no more than 3000 microns, or no more than 1500 microns, or no more than 1000 microns.

Embodiment 168 The method according to any of embodiments 149-162, wherein the fourth threshold value is in the range of 50-5000 microns, e.g., 50-3000 microns, or 50-1500 microns, or 50-1000 microns, or 100-5000 microns, or 100-3000 microns, or 100-1500 microns, or 100-1000 microns, or 250-5000 microns or 250-3000 microns, or 250-1500 microns, or 250-1000 microns, or 400-5000 microns, or 400-3000 microns, or 400-1500 microns, or 400-1000 microns.

Embodiment 169. The method according to any of embodiments 149-162, wherein the fourth threshold value is in the range of 500-5000 microns, e.g., 500-3000 microns, or 500-1500 microns, or 500-1000 microns, or 600-5000 microns or 600-3000 microns, or 600-1500 microns, or 600-1000 microns.

Embodiment 170. The method according to any of embodiments 149-162, wherein the fourth threshold value is in the range of 700-5000 microns, e.g., 700-3000 microns, or 700-1500 microns, or 700-1000 microns, or 800-5000 microns or 800-3000 microns, or 800-1500 microns, or 900-5000 microns, or 900-3000 microns, or 900-1500 microns.

Embodiment 171. A method for preparing a product comprising an unexpanded perlite, the method comprising characterizing an unexpanded perlite as a high-expansion perlite via the method of any of embodiments 101-170; and including the unexpanded perlite in the product.

Embodiment 172. The method of embodiment 171, wherein the including the unexpanded perlite in the product comprises including the unexpanded perlite in an unset plaster composition, and allowing the unset plaster composition to set.

Embodiment 173. The method according to any of embodiments 51-59 or 83-88, further comprising characterizing a candidate unexpanded perlite as a high-expansion perlite via the method of any of embodiments 101-170, and selecting the unexpanded perlite for use as the unexpanded perlite in the method.

Embodiment 174. A method of making a fire-resistant set gypsum material as defined in any of embodiments 61-74, the method comprising:
providing a moist composition comprising stucco, water, and unexpanded perlite;
allowing the moist composition to set to from a wet gypsum material; and
drying the wet gypsum material at a temperature in the range of 50-350° C. to provide the set gypsum material,
wherein the unexpanded perlite is as defined in any of embodiments 61-74.

Embodiment 175. A fire-resistant building board comprising a set gypsum core having a first major surface and a second, opposing major surface, wherein the set gypsum core comprises (preferably is) a fire-resistant set gypsum material as defined in any of embodiments 61-74.

Embodiment 176. A method of forming a fire-resistant building board as defined in embodiment 175, comprising:
providing a slurry comprising stucco, water, and unexpanded perlite;
allowing the slurry to set to form a wet gypsum core; and
drying the wet gypsum core at a temperature in the range of 50-350° C. to provide the set gypsum core,
wherein the unexpanded perlite is as defined in any of embodiments 61-74.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice. Thus, before the disclosed processes and devices are described, it is to be understood that the aspects described herein are not limited to specific embodiments, apparatuses, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. It will be further understood that the endpoints of each of the ranges are significant both in relation to the other endpoint, and independently of the other endpoint.

All methods described herein can be performed in any suitable order of steps unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

1. A fire-resistant set gypsum material comprising
a set body of calcium sulfate dihydrate; and
dispersed in the set body of calcium sulfate dihydrate, an unexpanded perlite, the unexpanded perlite having one or more of
(a) a first mass loss of at least a first threshold value, the first threshold value being at least 0.7 wt %, the first mass loss being determined by subjecting the unexpanded perlite to thermogravimetric analysis (TGA) at a first heating rate of 20° C./minute over a first temperature range from a first lower limit of 700° C. to a first upper limit of 900° C. and determining as the first mass loss the mass lost over the first temperature range;
(b) a second mass loss of at least a second threshold value, the second threshold value being at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
(c)
(i) a third mass loss of at least a third threshold value, the third threshold value being at least 0.45 wt %, the third mass loss being a difference between a stabilized mass of the unexpanded perlite at a third lower temperature of 500° C. and a stabilized mass of the sample at a third upper temperature that is 1000° C.; and
(ii) a D50 particle size of at least a fourth threshold value, the fourth threshold value being 400 microns.

2. The fire-resistant set gypsum material according to claim 1, wherein the unexpanded perlite has (a) a first mass loss of at least a first threshold value, the first threshold value being at least 0.7 wt %, the first mass loss being determined by subjecting the unexpanded perlite to thermogravimetric analysis (TGA) at a first heating rate of 20° C./minute over a first temperature range from a first lower limit of 700° C. to a first upper limit of 900° C. and determining as the first mass loss the mass lost over the first temperature range.

3. The fire-resistant set gypsum material according to claim 1, wherein the first threshold value is at least 0.75 wt %.

4. The fire-resistant set gypsum material according to claim 1, wherein the unexpanded perlite has (b) a second mass loss of at least a second threshold value, the second threshold value being at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit.

5. The fire-resistant set gypsum material according to claim 1, wherein the second threshold value is at least 0.07 wt %.

6. The fire-resistant set gypsum material according to claim 1, wherein the unexpanded perlite has (c) (i) a third mass loss of at least a third threshold value, the third threshold value being at least 0.45 wt %, the third mass loss being a difference between a stabilized mass of the unexpanded perlite at a third lower temperature of 500° C. and a stabilized mass of the sample at a third upper temperature that is 1000° C.; and (ii) a D50 particle size of at least a fourth threshold value, the fourth threshold value being 400 microns.

7. The fire-resistant set gypsum material according to claim 1, wherein the third threshold value is at least 0.5 wt %.

8. The fire-resistant set gypsum material according to claim 1, wherein the fourth threshold value is at least 500 microns.

9. The fire-resistant set gypsum material according to claim 1, wherein the unexpanded perlite has one or both of:
(b) a second mass loss of at least a second threshold value, the second threshold value being at least 0.04 wt %, the second mass loss being determined by subjecting the unexpanded perlite to TGA at a heating rate of 30° C./minute over a second temperature range from a second lower limit of 600° C. to a second upper limit of 800° C. and determining as the second mass loss an excess mass loss over the second temperature range, the excess mass loss being defined as a mass loss in excess of a mass loss represented by a line interpolated on a graph of mass loss vs. temperature from the second lower limit to the second upper limit; and
(c) (i) a third mass loss of at least a third threshold value, the third threshold value being at least 0.45 wt %, the third mass loss being a difference between a stabilized mass of the unexpanded perlite at a third lower temperature of 500° C. and a stabilized mass of the sample at a third upper temperature that is 1000° C.; and (ii) a D50 particle size of at least a fourth threshold value, the fourth threshold value being 400 microns.

10. The fire-resistant set gypsum material according to claim 9, wherein the unexpanded perlite further has (a) a first mass loss of at least a first threshold value, the first threshold value being at least 0.7 wt %, the first mass loss being determined by subjecting the unexpanded perlite to thermogravimetric analysis (TGA) at a first heating rate of 20° C./minute over a first temperature range from a first lower limit of 600° C. to a first upper limit of 800° C. and determining as the first mass loss the mass lost over the first temperature range.

11. The fire-resistant set gypsum material according to claim 1, wherein the unexpanded perlite has a D50 particle size of at least 100 microns.

12. The fire-resistant set gypsum material according to claim 1, wherein the unexpanded perlite is present in an amount of at least 0.5 wt %, based on the weight of the set gypsum material.

13. A method of making a fire-resistant set gypsum material according to claim 1, the method comprising:
providing a moist composition comprising stucco, water, and unexpanded perlite;
allowing the moist composition to set to from a wet gypsum material; and
drying the wet gypsum material at a temperature in the range of 50-350° C. to provide the set gypsum material.

14. A fire-resistant building board comprising a set gypsum core having a first major surface and a second, opposing major surface, wherein the set gypsum core comprises a fire-resistant set gypsum material according to claim 1.

15. A method of forming a fire-resistant building board as defined in claim 14, comprising:
providing a slurry comprising stucco, water, and unexpanded perlite;
allowing the slurry to set to form a wet gypsum core; and
drying the wet gypsum core at a temperature in the range of 50-350° C. to provide the set gypsum core.

16. A method for characterizing a sample of unexpanded perlite with respect to thermal expansion performance, the method comprising performing one or more of the following:
(a)
subjecting the unexpanded perlite to thermogravimetric analysis (TGA) at a first heating rate of at least 10° C./minute over a first temperature range from a first lower limit of no more than 700° C. to a first upper limit of at least 800° C.;
determining a first mass loss over the first temperature range; and
characterizing the unexpanded perlite as high-expansion perlite if the first mass loss is at least a first threshold value;
wherein the first threshold value is at least 0.1 wt %;
(b)
subjecting the unexpanded perlite to thermogravimetric analysis (TGA) at a second heating rate of at least 20° C./minute over a second temperature range from a second lower limit of in the range of 500-700° C. to a second upper limit of at least 700° C., the second temperature range covering at least 100° C. in temperature difference;
determining a second mass loss, the second mass loss being an excess mass loss over the second temperature range, the excess mass loss being defined as a mass loss in excess of a mass loss represented by a line interpolated on a graph of mass loss vs. temperature from the second lower limit to the second upper limit; and
characterizing the unexpanded perlite as high-expansion perlite if the second mass loss is at least a second threshold value,
wherein the second threshold value is at least 0.0 wt %; and
(c)
providing a D50 particle size of the unexpanded perlite;
determining a third mass loss of the unexpanded perlite, the third mass loss being a difference between a stabilized mass of the sample at a third lower temperature that is in the range of 400-550° C. and a stabilized mass of the sample at a third upper temperature of at least 600° C.; and
characterizing the unexpanded perlite as high-expansion perlite if the third mass loss is at least a third threshold value, and
the D50 particle size of the sample is at least a fourth threshold value,
wherein the third threshold value is at least 0.1 wt %, and the fourth threshold value is at least 50 microns.

17. The method according to claim 16, the method comprising performing:
(a)
subjecting the unexpanded perlite to thermogravimetric analysis (TGA) at a first heating rate of at least 10° C./minute over a first temperature range from a first lower limit of no more than 700° C. to a first upper limit of at least 800° C.;
determining a first mass loss over the first temperature range; and
characterizing the unexpanded perlite as high-expansion perlite if the first mass loss is at least a first threshold value,
wherein the first threshold value is at least 0.1 wt %.

18. The method according to claim 16, the method comprising performing:
(b)
subjecting the unexpanded perlite to thermogravimetric analysis (TGA) at a second heating rate of at least 20° C./minute over a second temperature range from a second lower limit of in the range of 500-700° C. to a second upper limit of at least 700° C., the second temperature range covering at least 100° C. in temperature difference;
determining a second mass loss, the second mass loss being an excess mass loss over the second temperature range, the excess mass loss being defined as a mass loss in excess of a mass loss represented by a line interpolated on a graph of mass loss vs. temperature from the second lower limit to the second upper limit; and
characterizing the unexpanded perlite as high-expansion perlite if the second mass loss is at least a second threshold value,
wherein the second threshold value is at least 0.0 wt %.

19. The method according to claim 16, wherein the unexpanded perlite is characterized as a high-expansion perlite only if it has a D50 particle size of at least 100 microns.

20. The method according to claim 16, the method comprising performing:
(c)
providing a D50 particle size of the unexpanded perlite;
determining a third mass loss of the unexpanded perlite, the third mass loss being a difference between a stabilized mass of the sample at a third lower temperature that is in the range of 400-550° C. and a stabilized mass of the sample at a third upper temperature of at least 600° C.; and
characterizing the unexpanded perlite as high-expansion perlite if the third mass loss is at least a third threshold value, and the D50 particle size of the sample is at least a fourth threshold value,
wherein the third threshold value is at least 0.1 wt %, preferably at least 0.45 wt %, more preferably at least 0.5 wt %, and the fourth threshold value is at least 50 microns.

21. The method according to claim 16, wherein the first lower limit is at least 400° C.
